(19) United States
(12) Patent Application Publication
(10) Pub. No.: US 2024/0121194 A1
(43) Pub. Date: Apr. 11, 2024

(54) METHOD AND APPARATUS FOR BUFFER MANAGEMENT IN LOAD BALANCING

(71) Applicant: Intel Corporation, Santa Clara, CA (US)

(72) Inventors: Niall MCDONNELL, Limerick (IE); Ambalavanar ARULAMBALAM, Center Valley, PA (US); Bruce RICHARDSON, Shannon (IE); Te MA, Allentown, PA (US)

(21) Appl. No.: 18/392,028

(22) Filed: Dec. 21, 2023

(51) Int. Cl. H04L 47/125; H04L 47/30; H04L 47/625

(52) U.S. Cl. CPC H04L 47/125; H04L 47/30; H04L 47/6255

(57) ABSTRACT

Methods, apparatus, and computer programs are disclosed for buffer management in load balancing. In one embodiment, a method is disclosed to comprise providing a set of buffers by a storage of a load balancer to store packets to be distributed by the load balancer, and distributing the packets by the load balancer to a set of cores of a computer processor to be processed by the set of cores. The method further comprises responsive to buffer utilization in the storage over a first threshold, obtaining by circuitry of the load balancer, from top of a memory stack coupled to the storage, additional buffers to store the packets to be distributed and responsive to buffer utilization in the storage below a second threshold, returning by the circuitry of the load balancer, available buffers in the storage to the top of the memory stack.

### TECHNICAL FIELD

Embodiments of the disclosure relate to the field of computing; and more specifically, the embodiments are related to buffer management in load balancing.

### BACKGROUND ART

A load balancer is a hardware circuit to optimize the distribution of workload across cores in a multi-core processor. The load balancer balances the workload of applications running on the multi-core processor for achieving high performance and resource utilization, and the balancing is based on utilization of the cores so that no core is overburdened while other cores remain idle.

A load balancer may be used to balance the workload from a traffic producer (e.g., a network interface controller (NIC), storage device, accelerators, or input/output (I/O) device) and needs to provide buffers to the traffic produce for storing and queuing the workload. The queuing often occupies a large memory footprint, particularly for run-to-completion applications where packets of an application are to be processed by the same core. While the load balancer may aggregate I/O data (e.g., packets) to multiple cores in the same queue, the cost of managing buffers and buffer descriptors to store the I/O data in the queue can be expensive and it is challenging to reduce the footprint of the buffers used in load balancing.

### BRIEF DESCRIPTION OF THE DRAWINGS

The disclosure may best be understood by referring to the following description and accompanying drawings that are used to show embodiments of the disclosure.

FIG. 1 illustrates buffer management by a load balancer per some embodiments.

FIG. 2 illustrates state transitions of buffers with buffer management by a load balancer per some embodiments.

FIG. 3 illustrates operations of a buffer cache of a load balancer interacting with storage per some embodiments.

FIG. 4 illustrates operations of components in a load balance processing pipeline per some embodiments.

FIG. 5 illustrates a flow diagram for operations of buffer management in load balancing per some embodiments.

FIG. 6 illustrates an example computing system.

FIG. 7 illustrates a block diagram of an example processor and/or System on a Chip (SoC) that may have one or more cores and an integrated memory controller.

FIG. 8 is a block diagram illustrating a computing system configured to implement one or more aspects of the examples described herein.

FIG. 9A illustrates examples of a parallel processor.

FIG. 9B illustrates examples of a block diagram of a partition unit.

FIG. 9C illustrates examples of a block diagram of a processing cluster within a parallel processing unit.

FIG. 9D illustrates examples of a graphics multiprocessor in which the graphics multiprocessor couples with the pipeline manager of the processing cluster.

FIGS. 10A-10C illustrate additional graphics multiprocessors, according to examples.

FIG. 11 shows a parallel compute system 1100, according to some examples.

FIGS. 12A-12B illustrate a hybrid logical/physical view of a disaggregated parallel processor, according to examples described herein.

FIG. 13A is a block diagram illustrating both an example in-order pipeline and an example register renaming, out-of-order issue/execution pipeline according to examples.

FIG. 13B is a block diagram illustrating both an example in-order architecture core and an example register renaming, out-of-order issue/execution architecture core to be included in a processor according to examples.

FIGS. 14A-14B illustrate thread execution logic including an array of processing elements employed in a graphics processor core according to examples described herein.

FIG. 15 is a block diagram of another example of a graphics processor.

### DETAILED DESCRIPTION

In the following description, numerous specific details are set forth. However, it is understood that embodiments of the disclosure may be practiced without these specific details. In other instances, well-known circuits, structures, and techniques have not been shown in detail in order not to obscure the understanding of this description.

Bracketed text and blocks with dashed borders (such as large dashes, small dashes, dot-dash, and dots) may be used to illustrate optional operations that add additional features to the embodiments of the disclosure. Such notation, however, should not be taken to mean that these are the only options or optional operations, and/or that blocks with solid borders are not optional in some embodiments of the disclosure.

References in the specification to “one embodiment,” “an embodiment,” “an example embodiment,” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “connected” means a direct electrical or magnetic connection between the things that are connected, without any intermediary devices, while the term “coupled” means either a direct electrical or magnetic connection between the things that are connected or an indirect connection through one or more passive or active intermediary devices. The term “circuit” means one or more passive and/or active components that are arranged to cooperate with one another to provide a desired function. A “set,” as used herein, refers to any positive whole number of items including one item.

Buffer Management for a Load Balancer

To process packets through a load balancer, software applications may be implemented to forward the packets through the load balancer, and since buffers are where packets are stored to be distributed by the load balancer, the software applications provide buffer management functions to allocate buffers for the packets to be distributed to cores of a processor and the packets to be aggregated after being processed by the cores. For example, the Data Plane Development Kit (DPDK) or OpenDataPlane (ODP) may be used to help developers build a packet processing application that executes a buffer management function at a load balancer, a core, and/or a traffic producer. A buffer management function used by a packet processing software application, however, tends to maintain a large memory footprint owing to the packet queuing requirements. This is especially true for a processor in a networks node that has large bandwidth delay products, out-or-order buffers, and/or Quality-of-Service (QoS) buffering.

For example, a receiving queue for packets to be distributed by a load balancer typically keeps a sufficient number of empty buffers to store the packets. While this allows the receiving queue to absorb bursts of traffic, many of the buffer storing packets to be distributed are often empty and/or unused. The receiving queue and transmitting queue of a load balancer are paired and cause the buffer management function to maintain a large footprint in buffer usage. For example, a buffer management function may be able to process 512 queue entries and each entry corresponding to a packet of size up to 1 Kilo bytes (1 KB), the buffer management function may need 1 MB to manage buffers, as 1 KB per entry * 512 entries * 2 (both transmitting and receiving queues)=1 MB. That is a substantial storage even on a model processor. Standard Ethernet packets sizes (1,518 bytes) are often stored in buffers that are 2 KB to allow for memory page alignment, thereby doubling the storage of the above example. A buffer management function with more substantial queues lengths (e.g., 2048 entries or more) and buffer sizes (e.g., 9 KB jumbo frames) can have a much higher storage requirement. To avoid the storage requirement by the buffer management function, a load balancer is designed to manage buffers and/or buffer queues (e.g., descriptor rings) per some embodiments. Note that the use of the term “packet” represents the workload to be distributed through a load balancer, and a packet includes one or more header(s) that contains control information and a payload that contains actual data being transmitted or received. A packet as used herein, is intended to be broadly construed to include a frame, a datagram, a packet, I/O data, or a cell; a fragment of a frame, a fragment of a datagram, a fragment of a packet, or a fragment of a cell; or another type, arrangement, or packaging of data.

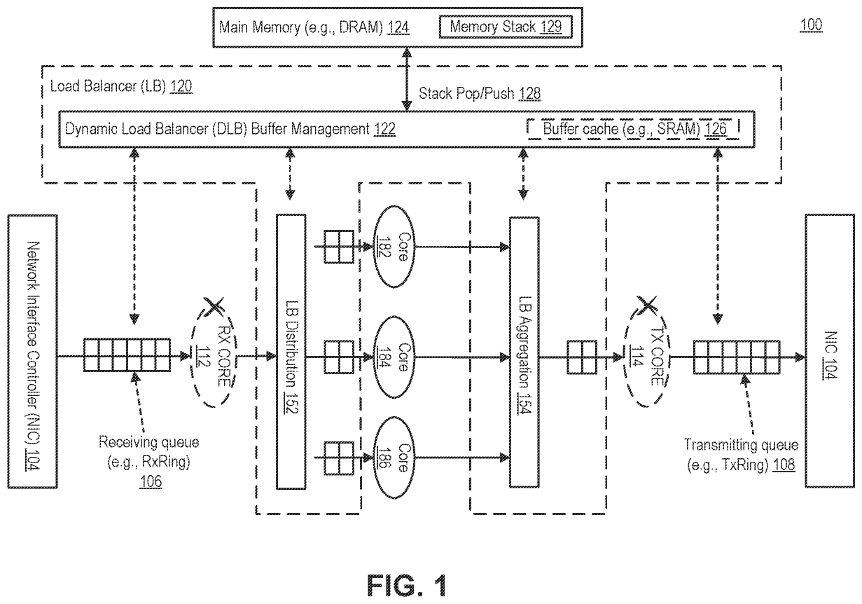

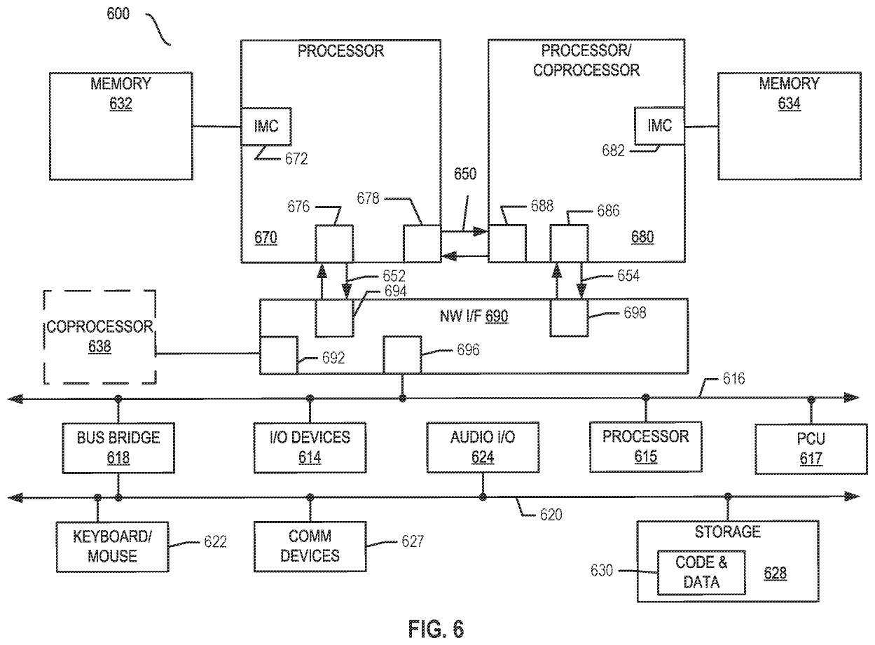

FIG. 1 illustrates buffer management by a load balancer per some embodiments. System 100 may be a computing system/processor discussed herein relating to FIGS. 6 to 15. System 100 includes a network interface controller (NIC) 104 that both provide packets to a receiving queue 106 and disposes packets from a transmitting queue 108, load balancer (LB) distribution logic/circuitry 152 that distributes packets in the load balance packet processing pipeline, where the packets arriving from NIC 104 are distributed to a set of cores (e.g., cores 182, 184, and 186) of system 100, and the packets processed by the set of cores are then aggregated by DLB aggregation logic/circuitry 154. The LB distribution and aggregation logic/circuitry 152 and 154 belong to a Load Balancer (LB) 120 of System 100, which includes a main memory 124 that is coupled with LB buffer management logic/circuitry 122. LB buffer management logic/circuitry 122 includes or is coupled with a buffer cache 126 that may be used for application buffers of LB 120 to provide storage to store packets of LB 120. The term “application buffer” is to differentiate the buffers for the DLB's receiving/transmitting queue from the buffers used elsewhere (e.g., the internal buffers within a load balancer for load balancer internal queues). Unless noted otherwise, the buffers discussed herein are application, stack, device driver, or operating system buffers to be used to store packets in a load balance packet processing pipeline from a traffic producer. Also, a dynamic load balancer (DLB) is used as an example of load balancers sometimes to implement embodiments discussed herein, and the “dynamic” in DLB indicates that the load balancer may adapt its load balancing behavior in real time based on the current workload and system conditions, and embodiments herein are not limited to the feature or the any particular ways that such adaption is achieved. Packet data may be written directly into an application buffer by either the load balancer or NIC in accordance with a remote direct memory access protocol.

Note that while NIC 104 is shown as the producer of packets for distribution by LB 120, alternative embodiments may have a different producer providing packets to a load balancer (e.g., LB 120) without going through a NIC, e.g., the producer may be a hardware such as a router, a firewall, a gateway/router/switch, a vSwitch, an application delivery controller, an Infrastructure Processing Unit (IPU), Data Processing Unit (DPU), Edge Processing Unit (EPU), another other Processing Unit (xPU), or a server connected to a content delivery network, or an application that provides packets to and/or sinks packets from, another application and/or network. Embodiments of the invention apply to a load balancer that interacts with a traffic producer by ingress and/or egress of packets through a receiving queue and/or a transmitting queue.

In some embodiments, main memory 124 is not a part of LB 120 and is shared with other components of System 100. Alternatively, main memory 124 may be implemented within LB 120. Main memory 124 has significantly larger storage than buffer cache 126 of LB 120 but it takes LB 120 longer time (more delay) to access main memory 124 than buffer cache 126. In some embodiments, main memory 124 is made using Dynamic Random-Access Memory (DRAM) while buffer cache 126 is made using Static Random-Access Memory (SRAM), since SRAM is faster but more expensive than DRAM. Other types of memory may be used so that LB 120 may access buffer cache 126 with faster access speed but smaller storage space than main memory 124 in alternative embodiments.

The receiving queue 106 may be implemented using a receive ring (Rx ring or RxRing) while the transmitting queue 108 may be implemented using a transmit ring (Tx ring or TxRing) in some embodiments. Each of the receive and transmit rings may be implemented as a set of circular buffers that is written in a round-robin fashion and new data overwrite the oldest data in the set of circular buffers when the respective queue is full. Alternatively, the ring may stop taking new requests when there is no room available for the request. When the ring enters full or near full state, it may alert another part of the system to the low or no-availability condition.

In existing approaches, a receiving core 112 is used to collect packets from the receiving queue 106 to be provided to LB distribution logic/circuitry 152, and a transmitting core 114 is used to obtain the aggregated packets from LB aggregation logic/circuitry 154. The receiving/transmitting cores 112/114 are dedicated to managing packets in the receiving/transmitting queues 106/108, and a buffer management function may be executed by the receiving/transmitting cores 112/114 for buffer management interacting with receiving/transmitting queues 106/108, LB distribution logic/circuitry 152, LB aggregation logic/circuitry 154, and/or NIC 104. The execution of the buffer management function on the receiving/transmitting cores 112/114 requires concurrent atomic access to the main memory 124 and the atomic access tends to be expensive in terms of cycle spent on the execution. The buffer management function typically keeps a large number of empty buffers to store packets to be executed through a load balance processing pipeline that includes NIC 104, receiving/transmitting queues 106/108, LB 120, and cores 182 to 186 because the receiving/transmitting queue deploys buffers in a First In, First Out (FIFO) fashion, and sufficient empty buffers are needed to avoid dropping packets.

Yet LB 120 may interact with NIC 104 directly without relying on the receiving/transmitting cores 112/114 to execute a buffer management function. With LB 120 implementing buffer cache 126, LB 120 may skip the receiving/transmitting cores 112/114 and use LB buffer management logic/circuitry 122 to directly manage receiving/transmitting queues 106/108. To further limit the footprint for buffer management of LB 120, a memory stack 129 within main memory 124 may be dedicated to buffer management based on the packet volume in System 100. Memory stack 129 may be pushed to provide more storage for additional inflight buffers to accommodate packet bursts to LB 120 when necessary, and be dequeued (e.g., popped) to return storage back to main memory 124 once packet volume reduces. Through memory stack 129's Last In, First Out (LIFO) structure, the storage in main memory 124 to be used for LB buffer management logic/circuitry 122 may be kept to a minimum and/or scaled with traffic demands. The stack pop/push shown at reference 128 will be discussed in further detail below.

Thus System 100 no longer implements a receiving/transmitting core pair for LB 120 in some embodiments, and LB 120 performs buffer management on its own through LB buffer management logic/circuitry 122 interacting with buffer cache 126 and main memory 124. With this LB 120 hardware centric approach in these embodiments, the buffer management may be faster in providing/releasing buffers for receiving/transmitting queues 106/108 than the earlier buffer management function centric approaches, and with the faster buffer management, the on-going large memory footprint for buffers in the buffer management function is may no longer be needed.

Note that LB buffer management logic/circuitry 122 can interact with an additional buffer management function when necessary. For example, the buffer management function may produce control packets upon interacting with NIC 104, LB 120, or cores 182 to 186, and these packets (not data packets provided to NIC 104 for distribution by LB 120) may be managed by LB buffer management logic/circuitry 122 through a storage outside of the ones for LB's buffer management through buffer cache 126 and memory stack 129 (e.g., a portion of main memory 124 may be used for the packets provided by the buffer management function).

State Transition of Buffers in a Load Balancer Process Pipeline

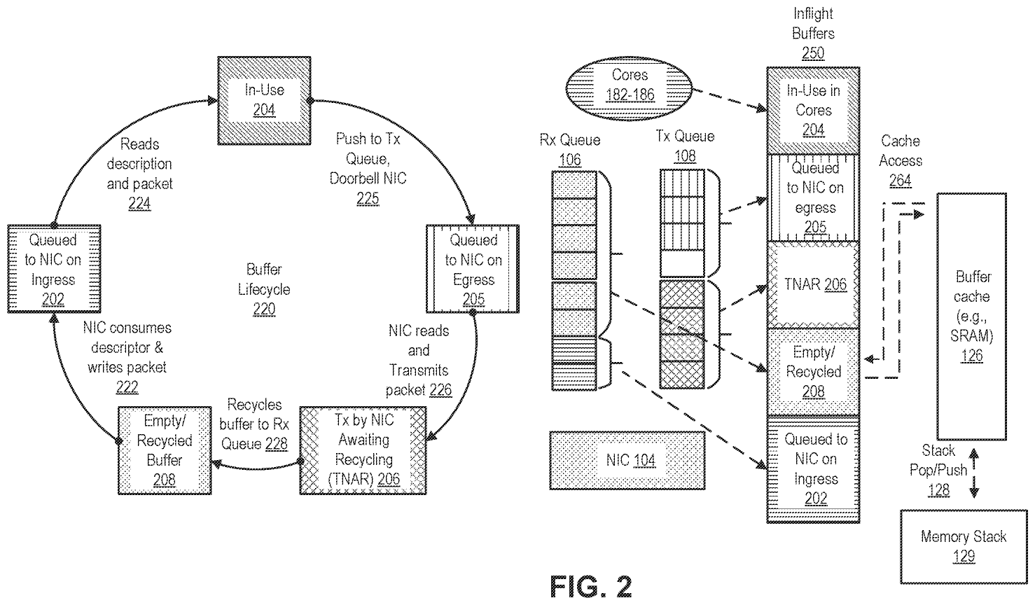

FIG. 2 illustrates state transitions of buffers with buffer management by a load balancer per some embodiments. The left side of FIG. 2 shows a buffer lifecycle 220, and the right side of FIG. 2 shows which components in System 100 that inflight buffers interact with. Inflight buffers are the buffers that store packets that are still in a load balancer processing pipeline, which includes NIC 104, receiving/transmitting queues 106/108, LB 120, and cores 182 to 106 in some embodiments. Once the one or more packets stored in an inflight buffer have been processed by the pipeline, e.g., being transmitted by NIC 104 after queuing in transmitting queue 108, the inflight buffer becomes an empty buffer, which may be recycled to store other one or more packets. For brevity of discussion herein below, one packet is stored in one buffer, and one queueing entity in receiving/transmitting queues 106/108 corresponds to one buffer that stores one packet as examples, but a buffer may store more than one packet, and one packet may span multiple buffers in some embodiments.

The initial state of an inflight buffer may start at reference 208, where the buffer may be initiated to the state when the corresponding storage space has not been used (“empty buffer”) for packet buffering by a load balancer processing pipeline. Alternatively, the buffer may reach the state when the corresponding storage space was used by a packet that has been transmitted by a NIC (e.g., NIC 104), the buffer no longer stores useful information, and the buffer is then recycled (“recycled buffer”) to store a new packet to be processed by the pipeline. In some embodiments, recycling a buffer may include “zeroing” or “zero filling” the buffer to ensure that prior content is not inadvertently made accessible to another process for which it is not intended. Although the term is called “zeroing,” the buffer may have all ones, alternating zeroes and ones, nonce data, random data, or other non-sensitive data written to the buffer to remove the prior contents.

Once an incoming packet arrives at the NIC, the NIC consumes the packet descriptor and writes a corresponding packet for the pipeline to process at reference 222. The packet descriptor contains a data structure that is used to describe the incoming packet (e.g., metadata) and information contained in the descriptor includes the incoming packet's source address, destination address, length, type, etc. Based on packet descriptor, the NIC writes the corresponding packet to the available (e.g., empty, not currently in-use) buffer in state 208, and the buffer is now in queued state at reference 202 and queued to the NIC on ingress, in a receiving queue (e.g., receiving queue 106) of a LB.

Once the buffer reaches the head of the receiving queue, the stored packet within will be distributed to one of the cores to which the LB distributes workloads, where the core reads the packet descriptor and the packet to process the packet at reference 224, and the buffer is then transitioned into an in-use state 204. Once the packet is processed by the core, it is aggregated toward the LB again, and the corresponding buffer is pushed to the transmitting queue (e.g., transmitting queue 108) of the NIC, and notifies the NIC that the buffer is enqueued at reference 225. In some embodiments, the notification is through a doorbell or message, where a specific memory-mapped register (doorbell register) is written so that the NIC receives a notification, and the NIC reads the specific memory-mapped register to understand the nature of the event (buffer in queue) and process it accordingly. The buffer is now in the queued state at reference 205 and queued to the NIC on egress.

Once the buffer reaches the head of the transmitting queue, the NIC will read and transmit the packet stored in the buffer at reference 226 to complete the process of the packet in the pipeline. Once the packet is transmitted, the buffer is transitioned into awaiting recycle state at reference 206. The buffer may then be recycled (e.g., through LB buffer management logic/circuitry 122) to be used by the receiving queue at reference 228. Once the recycling is done, the buffer returns to the initial state at reference 208.

While the buffer lifecycle shows the lifecycle of one inflight buffer, the inflight buffers in aggregation are shown at reference 250. These inflight buffers 250 store packets that are processed by cores 182 to 186 or queued in receiving/transmitting queues 106/108, and the respective lifecycle states of these buffers are shown.

Once existing inflight buffers 250 are exhausted and incoming packets are to be stored to be processed by the load balancer processing pipeline, buffer cache 126 replenishes storage space through cache access 264 to provide additional buffers to be used by the load balancer processing pipeline. The new empty buffers then enter their respective buffer lifecycles 220. Once surplus buffers are recycled without new incoming packets to be processed by the load balancer processing pipeline, the recycled buffers may be returned to buffer cache 126. In some embodiments, the cache access 264 is performed following LIFO. In other embodiments, factors such as priority, service level objectives (SLO), packet type (e.g., control or data), access patterns are weighed as considerations for cache management rather than a strict LIFO (e.g., stack) or FIFO (e.g., queue).

When buffer cache 126 is insufficient to provide the additional buffers, the memory stack 129 (this memory may be configured as a stack, queue, or random-access pool) may be used to provide the buffers to the load balancer for the load balancer processing pipeline. The memory stack 129 provides the buffers through stack pop/push 128.

Exemplary Operations in a Load Balance Processing Pipeline

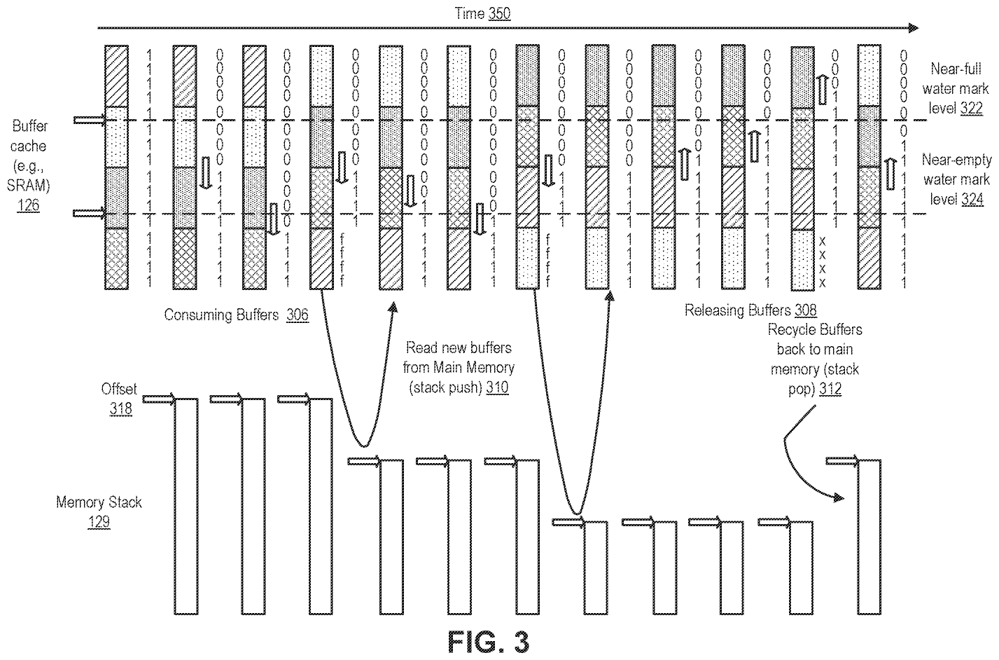

FIG. 3 illustrates operations of a buffer cache of a load balancer interacting with a memory stack per some embodiments. The buffer cache is buffer cache 126 and the memory stack is memory stack 129. The storage space of buffer cache 126 is split into four sections of equally sized quadrants each with a different pattern for illustration (other embodiments may not implement the split sections or may implement a different number of sections). The storage space may be viewed as storage entries to be provided as buffers to the load balance processing pipeline. When a storage entry is available to be used as a buffer, it is denoted with an indicium such as “1”/One (available) and the storage entry already occupied by an inflight buffer is denoted with “0”/Zero (unavailable), the availability of storage entries is shown at status columns. The fluctuation of buffer cache 126 occupancy level is shown over the timeline (at reference 350).

Buffer cache 126 maintains two watermark levels of occupancy, near-full and near-empty levels at references 322 and 324, respectively. Initially buffer cache 126 is full of available buffers, indicating by the status column of continuous Ones at the beginning of execution time. As traffic arrives from NIC 104 to LB 120, empty buffers are supplied to the receiving queue 106 from buffer cache 126 to replenish it. This buffer consumption, with the arrows downward (shown at reference 306), causes the storage entries to toggle from One to Zero (unavailable).

When the number of available buffers in buffer cache 126 drops below the near-empty watermark, buffer cache 126 reorders the quadrants to make space for new buffers while still preserving its LIFO nature. The (empty) quadrant that lived at the top of the stack is repositioned to the bottom and a read is launched to fill it with valid buffers (indicated with “f” in the status column) from memory stack 129 within main memory 124 as shown at reference 310. The level of buffers in memory stack 129 that are used by the load balancer processing pipeline increases as a result (as more storage spaces from memory stack 129 are used for buffering), and the process will repeat if and when the low watermark is passed again. The read from main memory 124 to use storage spaces is a stack push to memory stack 129, where more storage entries within memory stack 129 are used and the address offset 318 is moved downward.

At some point the rate of completions from transmitted packets in the load balancer processing pipeline will increase and there may be an increasing level of empty buffers in buffer cache 126. If this level passes the near-full water mark 322, the inverse process happens—the low quadrant is evicted to memory stack 129, where the eviction is indicated with “x” in the status column. Whether or not a write has to occur or not depends on whether these buffers were modified since the read from memory stack 129, and the now empty quadrant is repositioned to the top of buffer cache 126 to allow more space for recycled buffers. The buffer release (at reference 312) is shown with the arrows upward. The storage entries for the recycled buffers may then be returned to main memory (memory stack 129 specifically) as a stack pop at reference 312.

Through the stack push and pop at memory stack 129 interacting with buffer cache 126, the memory footprint in main memory 124 for a load balancer processing pipeline is greatly reduced compared to the ones used by a buffer management function, where the corresponding receiving queue and transmitting queue utilize the main memory without the buffer recycling mechanism to reuse vacated buffers to reduce the buffer management function's memory footprint, and the replenishing empty buffers and releasing surplus buffers through hardware—buffer cache 126 make buffer management respond much faster than a buffer management function.

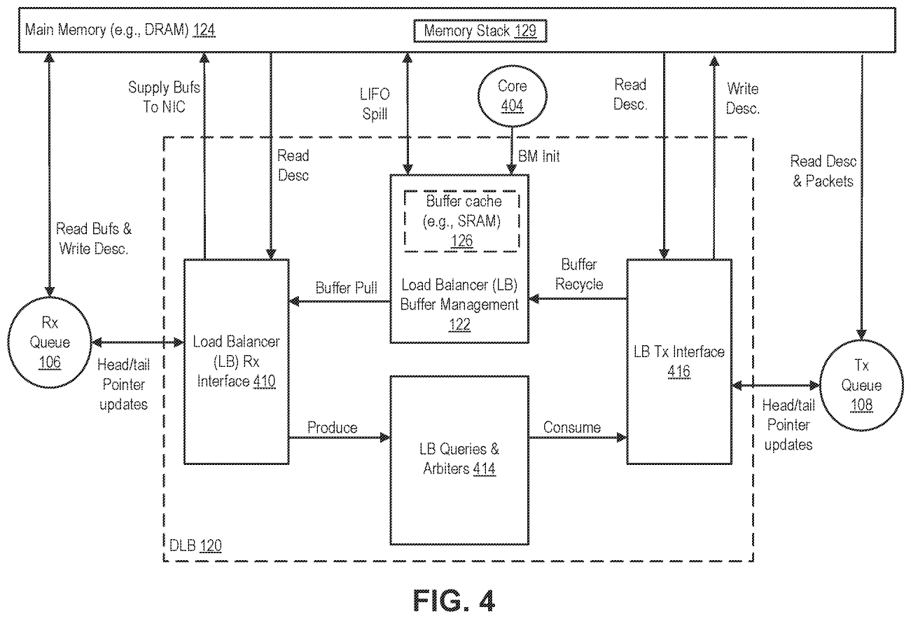

FIG. 4 illustrates operations of components in a load balance processing pipeline per some embodiments. The buffer management (BM) operations by LB buffer management logic/circuitry 122 of LB 120 may be initiated by a core 404 (e.g., one of cores 182 to 186). LB buffer management logic/circuitry 122 interacts with memory stack 129 (within main memory 124) and buffer cache 126 through stack pop/push, referred to as LIFO spill in the figure.

LB buffer management logic/circuitry 122 provides buffers to the LB's receiving interface 410, where the corresponding NIC (NIC 104) is informed about the availability of new buffers head/tail pointer updates. The buffers are read, and corresponding packet descriptions may be written to the buffers, which are then queued in the receiving queue 106. The LB receiving interface 410 may request buffers for the receiving queue 106 and read description about the buffers, and the buffers may be supplied by LB buffer management logic/circuitry 122 through buffer cache 126.

The LB receiving interface 410 acts as a producer to produce packets in one or more internal queues of LB 120 (where internal buffers may be deployed for the internal queues) that are consumed by LB transmitting interface 416 as the consumer. The producer-consumer mechanism is managed by LB queries and arbiter logic/circuitry 414.

The LB transmitting interface 416 provides packets processed by cores to the transmitting queue 108, and it reads and writes packet descriptions and recycles buffers to the buffer cache 126 and/or memory stack 129. The buffers and corresponding packets are processed and transmitted through the transmitting queue 108, where the head/tail points are updated through the queue processing. Once a packet is transmitted, the buffer used to store the packet is recycled.

Interaction between Buffer Management Function and Load Balancer's Buffer Management Logic/Circuitry

In FIG. 4, the LB transmitting interface 416 provides a recycled buffer, once the packet stored in the buffer is transmitted by a NIC coupled to the transmitting queue 108 (e.g., NIC 104). The LB transmitting interface 416 handles completion for the transmitted packet from the NIC. The NIC writes a queuing completion to memory mapped into the LB transmitting interface 416, which contains logic/circuitry to parse the transmitting queue 108 for buffers to be recycled when it receives the queuing completion. This works well in the regular operation where the load balancer's buffer management logic/circuitry, e.g., LB buffer management logic/circuitry 122, allocates the buffer for the packet.

Yet additional scenarios may exist in some embodiments when a buffer management function is implemented for the LB. For example, the buffer management function may drop a packet whose buffer was allocated by the load balancer's buffer management logic/circuitry, and the buffer needs to be recycled as well. Additionally, the buffer management function may wish to transmit a packet whose buffer did not originate in the LB, and the buffer should not be recycled.

In some embodiments, these scenarios are handled by indications (e.g., flags, indicia, semaphores, status bit(s), status fields) within a LB event structure that the buffer management function sends to the LB for each packet. The indication may include two-bit fields and referred to as drop/notify/recycle (DNR) in Table 1 below.

TABLE 1
Indications of Packets for Load Balancer Buffer Management

| | | Buffer management | Send to Tx | Recycle | |
|---|---|---|---|---|---|
| DNR | | function (BA) | Queue? | Buffers? | Comment |
| 0 | 0 | Transmit packet | Yes | Yes | Baseline - transmit packet and recycle |
| | | normally | | | buffers. No notification to the BA. |
| 0 | 1 | Packet buffer did | Yes | No | Packet transmitted but buffer not recycled. |
| | | not come from LB. | | | The credit is used to send the notification. |
| | | Buffer management | | | BA will recoup this credit - which must |
| | | function requires a | | | thereafter be returned to LB. |
| | | notification for | | | |
| | | such a transmitted | | | |
| | | packet. | | | |
| 1 | 0 | Buffer | No | Yes | Packet dropped and buffers recycled. |
| | | management | | | |
| | | function dropped a | | | |
| | | packet, the buffer | | | |
| | | is recycled & | | | |
| | | credit returned. | | | |
| 1 | 1 | Buffer management | No | No | Accumulate credit only - do not recycle or |
| | | function returns a | | | transmit. This indication is optional as other |
| | | credit | | | ways may be used to return credit. When |
| | | | | | this indication is not used, it may be treated |
| | | | | | as “reserved” or repurposed for another use. |

The LB event structure aids the LB buffer management logic/circuitry of a LB to manage/recycle buffers for the LB. Note that when a buffer management logic/circuitry of a load balancer interacts with a buffer management function for the same load balancer, the buffer management logic/circuitry may donate or receive a large number of buffers to and from the buffer management function, so that the buffer management function may perform its own buffer management. Such donate/receipt of buffers provides flexibility for the load balancer to scale/shrink the role of the buffer management function based on the operations of the buffer management logic/circuitry within the LB and the traffic characteristics. For example, upon a traffic burst and the buffer management logic/circuitry has insufficient storage to provide buffers to manage the receiving/transmitting queues, the buffer management logic/circuitry may interrupt the buffer management function to indicate the shortage of buffers, and the buffer management function may donate available buffers that it manages. Alternatively, the buffer management function may observe a surplus of buffers under its management and may donate available buffers to the buffer management logic/circuitry within the LB without being interrupted. After the traffic burst, the buffers may be returned to the buffer management function. The opposite operations occur when the buffer management logic/circuitry within the LB has a surplus of buffers under its management, it may donate a portion/all of the surplus to the buffer management function.

### Operations in Some Embodiments

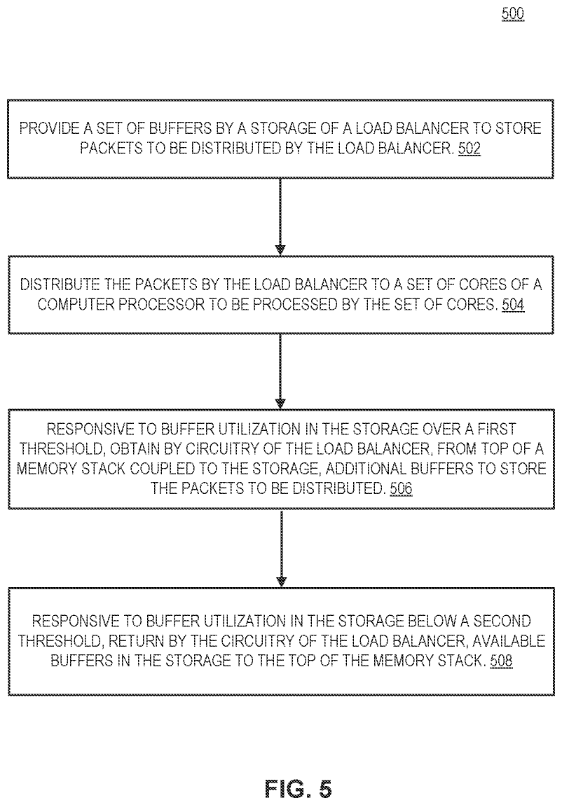

FIG. 5 illustrates a flow diagram for operations of buffer management in load balancing per some embodiments. The operations in method 500 are performed by a load balancer (e.g., LB 120) of a system (e.g., system 100) discussed herein.

At reference 502, a set of buffers is provided by a storage of the load balancer to store the packets to be distributed by the load balancer. At reference 504, packets are distributed by the load balancer to a set of cores of a computer processor to be processed by the set of cores.

At reference 506, responsive to buffer utilization in the storage being over a first threshold, from top of a memory stack coupled to the storage, additional buffers are obtained by circuitry of the load balancer to store packets to be distributed. At reference 508, responsive to the buffer utilization in the storage below a second threshold, available buffers in the storage are returned by circuitry of the load balancer to the top of the memory stack. The circuitry comprises LB buffer management logic/circuitry 122 in some embodiments.

In some embodiments, the available buffers from the storage were used to store packets that have been distributed by the apparatus. These buffers are recycled buffers shown in FIG. 2 in some embodiments.

In some embodiments, a determination that the buffer utilization in the storage being over the first threshold is performed upon a set of packets being queued to a receiving queue of the load balancer. The receiving queue is receiving queue 106 in some embodiments.

In some embodiments, a determination that the buffer utilization in the storage being below the second threshold is performed upon completion of a set of packets being transmitted from a transmitting queue of the load balancer. The transmitting queue is transmitting queue 108 in some embodiments.

In some embodiments, each of a receiving queue of the load balancer and a transmitting queue of the load balancer is a set of circular buffers. The circular buffers form the receive ring (Rx ring or RxRing) and transmit ring (Tx ring or TxRing) discussed herein above.

In some embodiments, for a packet processed by a core and to be transmitted by the load balancer through a transmitting queue of the load balancer, an indication is set to indicate whether to return a corresponding buffer to the top of the memory stack upon completion of queuing the packet in the transmitting queue. The indication is a flag shown in the discussion relating to Table 1 herein above.

In some embodiments, the indication is to indicate that the corresponding buffer is not to return to the top of the memory stack due to packet allocation to the corresponding buffer being performed by a party other than the circuitry of the load balancer.

In some embodiments, the indication is to indicate that the corresponding buffer is to return to the top of the memory stack upon the packet not being transmitted by the load balancer.

In some embodiments, the circuitry is coupled to a network interface module of the load balancer, from which the packets to be distributed are received, and to which packets processed by the set of cores are aggregated.

In some embodiments, the storage is to provide and release the set of buffers in an order of a latest available buffer to be provided first to incoming packets to the load balancer.

In some embodiments, a portion of the storage is excluded from determining the buffer utilization to interact with the memory stack, and wherein the portion of the storage is to be used for buffer management independently from the circuitry of the load balancer.

In some embodiments, a buffer management system for packet processing comprises: a load balancer comprising circuitry configured to connect to a network interface controller (NIC); a memory external to the load balancer for storing buffers; a set of watermark levels within the load balancer for managing buffer replenishment and recycling; and a mechanism for the load balancer to furnish buffers to the NIC on receive (Rx) and recycle buffers on transmit (Tx).

In some embodiments, the load balancer is further configured to manage the buffers without substantial involvement of software (SW) after initial setup. The software (SW) may be the buffer management function discussed herein in some embodiments.

In some embodiments, the load balancer includes a buffer manager integrated with the load balancer to manage the memory.

In some embodiments, the load balancer is configured to react within a time corresponding to one of more of the watermark levels to replenish NIC receive rings (RxRings) to maintain a low number of empty buffers.

In some embodiments, the load balancer is configured to handle packets dropped by software (SW) and packets originating from memory outside of the load balancer's control.

In some embodiments, the load balancer includes a transmit descriptor signal interface (TxDSI) and/or a receive descriptor signal interface (RxDSI) for connecting to NIC transmit (Tx) and/or receive (Rx) respectively.

In some embodiments, the load balancer is configured to parse a NIC transmit ring (TxRing) for buffers to recycle based on completions from transmitted packets.

In some embodiments, the load balancer utilizes a Drop/Notify/Recycle (DNR) indicia within an event structure to manage packet transmission and buffer recycling. In some embodiments, the DNR indicia indicates whether a packet's buffers originated from the load balancer and whether the buffers should be recycled. The implementation of the DNR indicia is discussed in further details herein above.

In some embodiments, the load balancer is configured to provide notifications to software (SW) when packets with buffers not originating from the load balancer are transmitted.

In some embodiments, the load balancer is configured to recycle buffers when packets are dropped by software (SW).

In some embodiments, the load balancer is configured to accumulate credit when software (SW) returns credit without recycling buffers or transmitting packets.

In some embodiments, the load balancer further comprises a cache within the load balancer for temporarily storing buffers.

In some embodiments, the cache operates in a last-in-first-out (LIFO) fashion. In some embodiments, the cache operates in a last-in-first-out (LIFO) fashion. In some embodiments, the cache is divided into quadrants, each quadrant being capable of being reordered based on buffer availability. In some embodiments, the reordering of quadrants preserves the LIFO nature of the cache.

In some embodiments, a computer-readable medium comprising instructions which, when executed by a processor, perform a method for managing buffers in a packet processing application, the method comprising: controlling a load balancer comprising circuitry to communicate to a network interface controller (NIC); managing buffer replenishment and recycling based on a set of watermark levels within the load balancer; and furnishing buffers to the NIC on receive (Rx) operations and recycling buffers on transmit (Tx) operations by the load balancer.

In some embodiments, the method further comprises managing the buffers by the load balancer without substantial involvement of software (SW) after initial setup.

In some embodiments, the method further comprises reacting within a time window corresponding a network slot time by the load balancer to replenish NIC receive rings (RxRings) to maintain a low number of empty buffers.

In some embodiments, the method further comprises handling by the load balancer of packets dropped by software (SW) and packets originating from memory outside of the load balancer's control.

In some embodiments, the method further comprises utilizing a Drop/Notify/Recycle (DNR) indicia within an event structure by the load balancer to manage packet transmission and buffer recycling.

In some embodiments, the method further comprises accumulating credit by the load balancer when software (SW) returns credit without recycling buffers or transmitting packets.

In some embodiments, the method further comprises operating a cache within the load balancer in a last-in-first-out (LIFO) fashion.

In some embodiments, the method further comprises dividing the cache into partitions and reordering the partitions based on buffer availability while preserving the LIFO nature.

In some embodiments, an apparatus for managing buffers in a packet processing application comprises: a load balancer comprising circuitry configured to directly connect to a network interface controller (NIC) and to manage buffer replenishment and recycling based on a set of watermark levels within the load balancer; and a first memory external to the load balancer for storing buffers, wherein the load balancer is further configured to furnish buffers to the NIC on receive (Rx) and recycle buffers on transmit (Tx).

In some embodiments, the load balancer within the apparatus is further configured to manage the buffers without substantial involvement of software (SW) after initial setup.

In some embodiments, the load balancer within the apparatus includes a buffer manager integrated with the load balancer to manage the first memory.

In some embodiments, the load balancer within the apparatus is configured to react quickly to replenish NIC receive rings (RxRings) to maintain a low number of empty buffers.

In some embodiments, the load balancer within the apparatus is configured to handle packets dropped by software (SW) and packets originating from a second memory, wherein the second memory is outside of the load balancer's management.

In some embodiments, the load balancer within the apparatus includes a transmit descriptor signal interface (TxDSI) and a receive descriptor signal interface (RxDSI) for connecting to NIC transmit (Tx) and receive (Rx) respectively.

In some embodiments, the load balancer within the apparatus includes is configured to parse a NIC transmit ring (TxRing) for buffers to recycle based on completions from transmitted packets.

In some embodiments, the load balancer within the apparatus utilizes indicia within an event structure to manage packet transmission and buffer recycling. In some embodiments, the indicia indicate whether a packet's buffers originated from the load balancer and whether the buffers should be recycled.

In some embodiments, the load balancer within the apparatus is configured to provide notifications to software (SW) when packets with buffers not originating from the load balancer are transmitted.

In some embodiments, the load balancer within the apparatus is configured to recycle buffers when packets are dropped by software (SW).

In some embodiments, the load balancer within the apparatus is configured to accumulate credit when software (SW) returns credit without recycling buffers or transmitting packets.

In some embodiments, the apparatus further comprises a cache within the load balancer for temporarily storing buffers. In some embodiments, the cache operates in a last-in-first-out (LIFO) fashion. In some embodiments, the cache is divided into segments, each segment being capable of being reordered based on buffer availability. In some embodiments, wherein the reordering of segments preserves the LIFO nature of the cache.

In some embodiments, the load balancer within the apparatus is further configured to interface with a computer program product comprising a non-transitory computer-readable medium having computer-readable program code embodied therein, the computer-readable program code adapted to be executed to implement a method for managing buffers in the packet processing application.

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable, and the embodiments are not limited to these exemplary systems and processors.

### Example Systems

FIG. 6 illustrates an example computing system. Multiprocessor system 600 is an interfaced system and includes a plurality of processors or cores including a first processor 670 and a second processor 680 coupled via an interface 650 such as a point-to-point (P-P) interconnect, a fabric, and/or bus. In some examples, the first processor 670 and the second processor 680 are homogeneous. In some examples, first processor 670 and the second processor 680 are heterogenous. Though the example system 600 is shown to have two processors, the system may have three or more processors, or may be a single processor system. In some examples, the computing system is a system on a chip (SoC).

Processors 670 and 680 are shown including integrated memory controller (IMC) circuitry 672 and 682, respectively. Processor 670 also includes interface circuits 676 and 678; similarly, second processor 680 includes interface circuits 686 and 688. Processors 670, 680 may exchange information via the interface 650 using interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a network interface (NW UF) 690 via individual interfaces 652, 654 using interface circuits 676, 694, 686, 698. The network interface 690 (e.g., one or more of an interconnect, bus, mesh, and/or fabric, and in some examples is a chipset) may optionally exchange information with a coprocessor 638 via an interface circuit 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via an interface such as P-P interconnect, such that either or both processors' local cache information may be stored in the shared cache if a processor is placed into a low power mode.

Network interface 690 may be coupled to a first interface 616 via interface circuit 696. In some examples, first interface 616 may be an interface such as a Peripheral Component Interconnect Express (PCIe) interconnect, Compute Express Link (CXL), NVLink, HyperTransport, or another I/O interconnect. In some examples, first interface 616 is coupled to a power control unit (PCU) 617, which may include circuitry, software, and/or firmware to perform power management operations with regard to the processors 670, 680 and/or coprocessor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interface 616, along with a bus bridge 618 which couples first interface 616 to a second interface 620. In some examples, one or more additional processor(s) 615, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 616. In some examples, second interface 620 may be a low pin count (LPC) interface. Various devices may be coupled to second interface 620 including, for example, a keyboard and/or mouse 622, communication devices 627 and storage circuitry 628. Storage circuitry 628 may be one or more non-transitory machine-readable storage media as described below, such as a disk drive or other mass storage device which may include instructions/code and data 630 and may implement a storage in some examples. Further, an audio I/O 624 may be coupled to second interface 620. Note that other architectures than the point-to-point architecture described above are possible. For example, instead of the point-to-point architecture, a system such as multiprocessor system 600 may implement a multi-drop interface or other such architecture.

In some examples, the LB 120 of System 100 is virtualized or “sliced” to allow multiple virtual machines access to the same physical hardware while maintaining access control. This virtualization may be implemented using Scalable IOV (SIOV), Single Root I/O Virtualization (SR-IOV) or the like to create virtual device interfaces, while isolating domains, and sharing a device as an Assignable Device Interface (ADI).

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

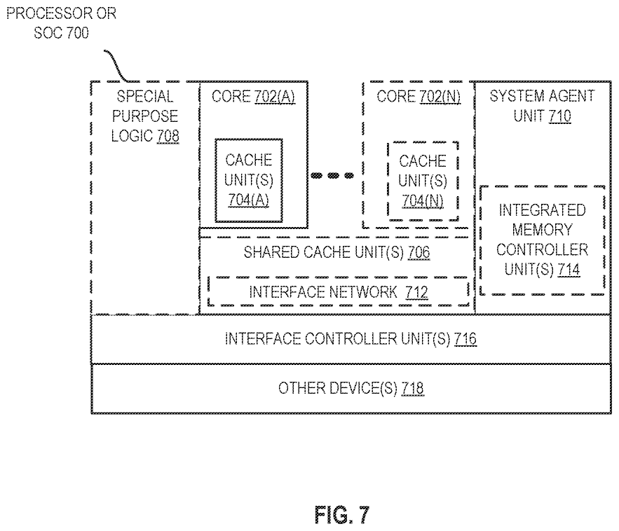

FIG. 7 illustrates a block diagram of an example processor and/or SoC 700 that may have one or more cores and an integrated memory controller. The solid lined boxes illustrate a processor 700 with a single core 702(A), system agent unit circuitry 710, and a set of one or more interface controller unit(s) circuitry 716, while the optional addition of the dashed lined boxes illustrates an alternative processor 700 with multiple cores 702(A)-(N), a set of one or more integrated memory controller unit(s) circuitry 714 in the system agent unit circuitry 710, and special purpose logic 708, as well as a set of one or more interface controller units circuitry 716. Note that the processor 700 may be one of the processors 670 or 680, or coprocessor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702(A)-(N) being one or more general purpose cores (e.g., general purpose in-order cores, general purpose out-of-order cores, or a combination of the two); 2) a coprocessor with the cores 702(A)-(N) being a large number of special purpose cores intended primarily for graphics and/or scientific (throughput); and 3) a coprocessor with the cores 702(A)-(N) being a large number of general purpose in-order cores.

Thus, the processor 700 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704(A)-(N) within the cores 702(A)-(N), a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples interface network circuitry 712 (e.g., a ring interconnect) interfaces the special purpose logic 708 (e.g., integrated graphics logic), the set of shared cache unit(s) circuitry 706, and the system agent unit circuitry 710, alternative examples use any number of well-known techniques for interfacing such units. In some examples, coherency is maintained between one or more of the shared cache unit(s) circuitry 706 and cores 702(A)-(N). In some examples, interface controller units circuitry 716 couple the cores 702 to one or more other devices 718 such as one or more I/O devices, storage, one or more communication devices (e.g., wireless networking, wired networking, etc.), etc.

In some examples, one or more of the cores 702(A)-(N) are capable of multi-threading. The system agent unit circuitry 710 includes those components coordinating and operating cores 702(A)-(N). The system agent unit circuitry 710 may include, for example, power control unit (PCU) circuitry and/or display unit circuitry (not shown). The PCU may be or may include logic and components needed for regulating the power state of the cores 702(A)-(N) and/or the special purpose logic 708 (e.g., integrated graphics logic). The display unit circuitry is for driving one or more externally connected displays.

The cores 702(A)-(N) may be homogenous in terms of instruction set architecture (ISA). Alternatively, the cores 702(A)-(N) may be heterogeneous in terms of ISA; that is, a subset of the cores 702(A)-(N) may be capable of executing an ISA, while other cores may be capable of executing only a subset of that ISA or another ISA.

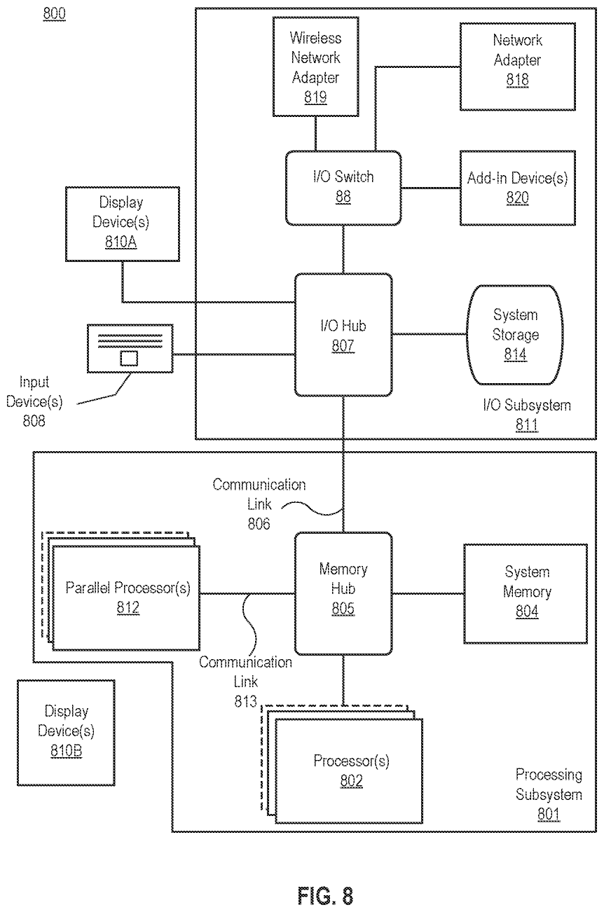

FIG. 8 is a block diagram illustrating a computing system 800 configured to implement one or more aspects of the examples described herein. The computing system 800 includes a processing subsystem 801 having one or more processor(s) 802 and a system memory 804 communicating via an interconnection path that may include a memory hub 805. The memory hub 805 may be a separate component within a chipset component or may be integrated within the one or more processor(s) 802. The memory hub 805 couples with an I/O subsystem 811 via a communication link 806. The I/O subsystem 811 includes an I/O hub 807 that can enable the computing system 800 to receive input from one or more input device(s) 808. Additionally, the I/O hub 807 can enable a display controller, which may be included in the one or more processor(s) 802, to provide outputs to one or more display device(s) 810A. In some examples the one or more display device(s) 810A coupled with the I/O hub 807 can include a local, internal, or embedded display device.

The processing subsystem 801, for example, includes one or more parallel processor(s) 812 coupled to memory hub 805 via a bus or other communication link 813. The communication link 813 may be one of any number of standards-based communication link technologies or protocols, such as, but not limited to PCI Express, or may be a vendor specific communications interface or communications fabric. The one or more parallel processor(s) 812 may form a computationally focused parallel or vector processing system that can include a large number of processing cores and/or processing clusters, such as a many integrated core (MIC) processor. For example, the one or more parallel processor(s) 812 form a graphics processing subsystem that can output pixels to one of the one or more display device(s) 810A coupled via the I/O hub 807. The one or more parallel processor(s) 812 can also include a display controller and display interface (not shown) to enable a direct connection to one or more display device(s) 810B.

Within the I/O subsystem 811, a system storage unit 814 can connect to the I/O hub 807 to provide a storage mechanism for the computing system 800. An I/O switch 816 can be used to provide an interface mechanism to enable connections between the I/O hub 807 and other components, such as a network adapter 818 and/or wireless network adapter 819 that may be integrated into the platform, and various other devices that can be added via one or more add-in device(s) 820. The add-in device(s) 820 may also include, for example, one or more external graphics processor devices, graphics cards, and/or compute accelerators. The network adapter 818 can be an Ethernet adapter or another wired network adapter. The wireless network adapter 819 can include one or more of a Wi-Fi, Bluetooth, near field communication (NFC), or other network device that includes one or more wireless radios.

The computing system 800 can include other components not explicitly shown, including USB or other port connections, optical storage drives, video capture devices, and the like, which may also be connected to the I/O hub 807. Communication paths interconnecting the various components in FIG. 8 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXLmem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Intel QuickPath Interconnect (QPI), Intel Ultra Path Interconnect (UPI), Intel On-Chip System Fabric (IOSF), Universal Chiplet Interconnect Express (UCIe), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 812 may incorporate circuitry optimized for graphics and video processing, including, for example, video output circuitry, and constitutes a graphics processing unit (GPU). Alternatively or additionally, the one or more parallel processor(s) 812 can incorporate circuitry optimized for general purpose processing, while preserving the underlying computational architecture, described in greater detail herein. Components of the computing system 800 may be integrated with one or more other system elements on a single integrated circuit. For example, the one or more parallel processor(s) 812, memory hub 805, processor(s) 802, and I/O hub 807 can be integrated into a system on chip (SoC) integrated circuit. Alternatively, the components of the computing system 800 can be integrated into a single package to form a system in package (SIP) configuration. In some examples at least a portion of the components of the computing system 800 can be integrated into a multi-chip module (MCM), which can be interconnected with other multi-chip modules into a modular computing system.

It will be appreciated that the computing system 800 shown herein is illustrative and that variations and modifications are possible. The connection topology, including the number and arrangement of bridges, the number of processor(s) 802, and the number of parallel processor(s) 812, may be modified as desired. For instance, system memory 804 can be connected to the processor(s) 802 directly rather than through a bridge, while other devices communicate with system memory 804 via the memory hub 805 and the processor(s) 802. In other alternative topologies, the parallel processor(s) 812 are connected to the I/O hub 807 or directly to one of the one or more processor(s) 802, rather than to the memory hub 805. In other examples, the I/O hub 807 and memory hub 805 may be integrated into a single chip. It is also possible that two or more sets of processor(s) 802 are attached via multiple sockets, which can couple with two or more instances of the parallel processor(s) 812.

Some of the particular components shown herein are optional and may not be included in all implementations of the computing system 800. For example, any number of add-in cards or peripherals may be supported, or some components may be eliminated. Furthermore, some architectures may use different terminology for components similar to those illustrated in FIG. 8. For example, the memory hub 805 may be referred to as a Northbridge in some architectures, while the I/O hub 807 may be referred to as a Southbridge.

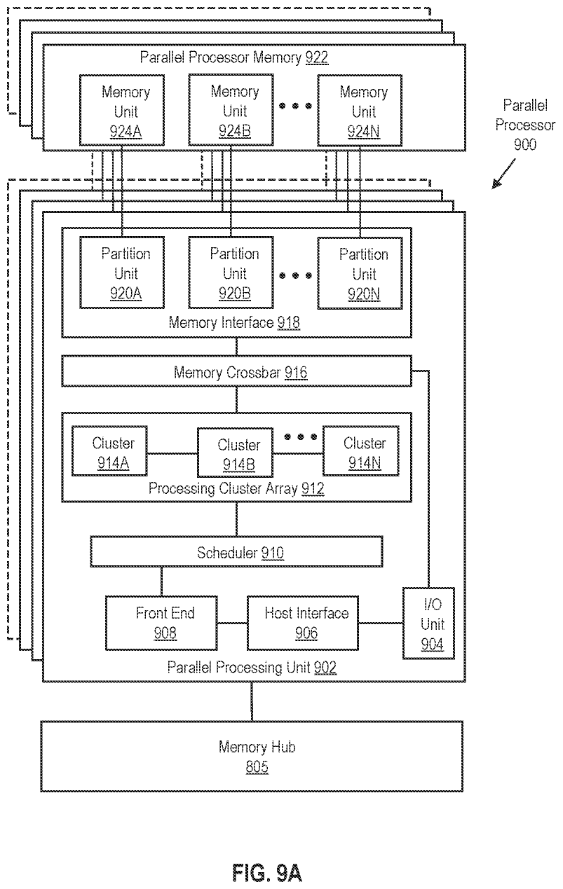

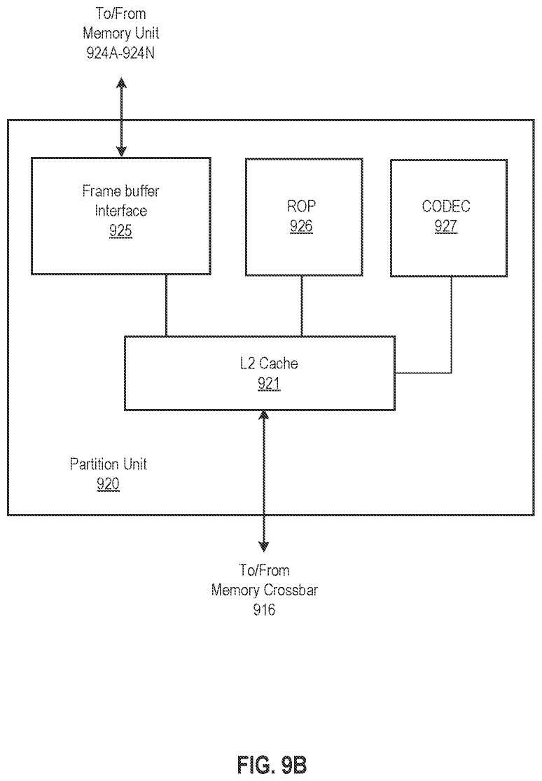

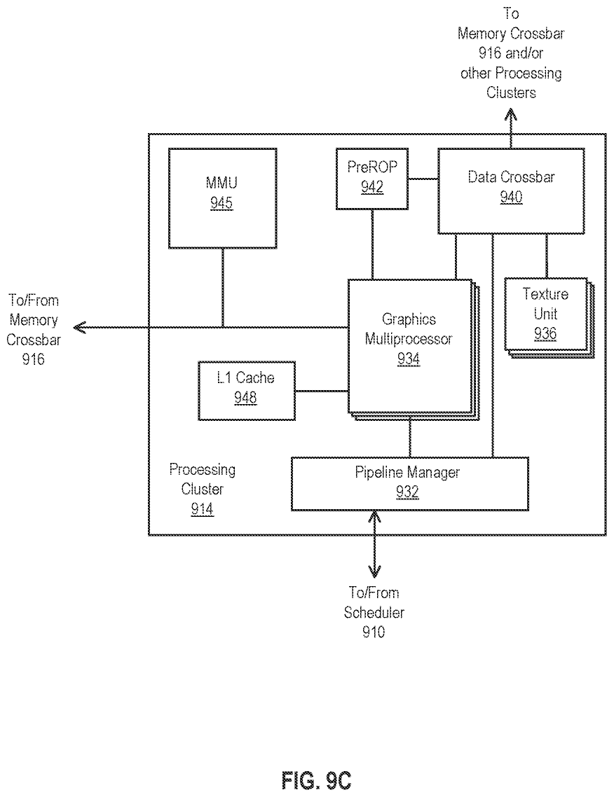

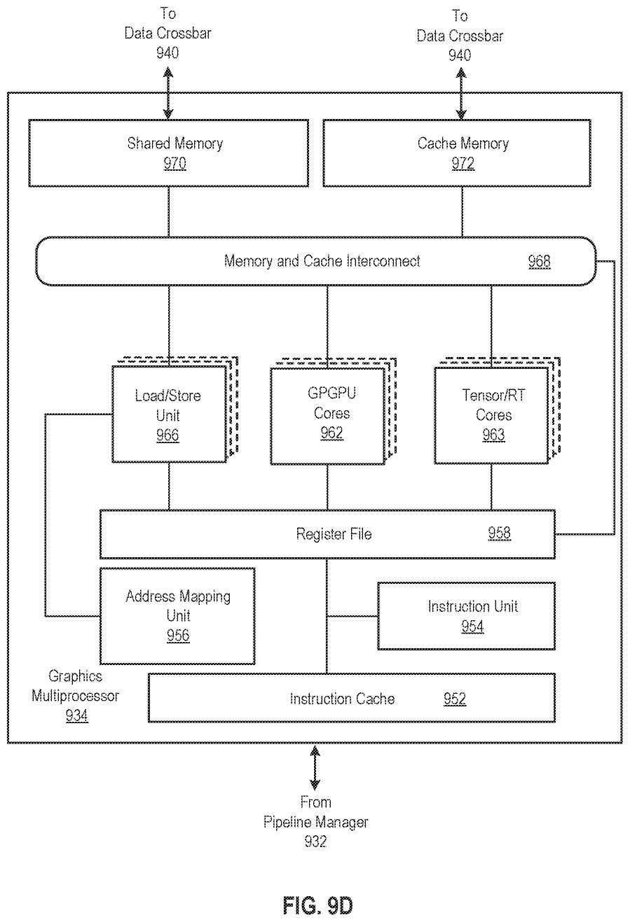

FIG. 9A illustrates examples of a parallel processor 900. The parallel processor 900 may be a GPU, GPGPU or the like as described herein. The various components of the parallel processor 900 may be implemented using one or more integrated circuit devices, such as programmable processors, application specific integrated circuits (ASICs), or field programmable gate arrays (FPGA). The illustrated parallel processor 900 may be one or more of the parallel processor(s) 812 shown in FIG. 8.

The parallel processor 900 includes a parallel processing unit 902. The parallel processing unit includes an I/O unit 904 that enables communication with other devices, including other instances of the parallel processing unit 902. The I/O unit 904 may be directly connected to other devices. For instance, the I/O unit 904 connects with other devices via the use of a hub or switch interface, such as memory hub 805. The connections between the memory hub 805 and the I/O unit 904 form a communication link 813. Within the parallel processing unit 902, the I/O unit 904 connects with a host interface 906 and a memory crossbar 916, where the host interface 906 receives commands directed to performing processing operations and the memory crossbar 916 receives commands directed to performing memory operations.

When the host interface 906 receives a command buffer via the I/O unit 904, the host interface 906 can direct work operations to perform those commands to a front end 908. In some examples the front end 908 couples with a scheduler 910, which is configured to distribute commands or other work items to a processing cluster array 912. The scheduler 910 ensures that the processing cluster array 912 is properly configured and in a valid state before tasks are distributed to the processing clusters of the processing cluster array 912. The scheduler 910 may be implemented via firmware logic executing on a microcontroller. The microcontroller implemented scheduler 910 is configurable to perform complex scheduling and work distribution operations at coarse and fine granularity, enabling rapid preemption and context switching of threads executing on the processing cluster array 912. Preferably, the host software can prove workloads for scheduling on the processing cluster array 912 via one of multiple graphics processing doorbells. In other examples, polling for new workloads or interrupts can be used to identify or indicate availability of work to perform. The workloads can then be automatically distributed across the processing cluster array 912 by the scheduler 910 logic within the scheduler microcontroller.

The processing cluster array 912 can include up to “N” processing clusters (e.g., cluster 914A, cluster 914B, through cluster 914N). Each cluster 914A-914N of the processing cluster array 912 can execute a large number of concurrent threads. The scheduler 910 can allocate work to the clusters 914A-914N of the processing cluster array 912 using various scheduling and/or work distribution algorithms, which may vary depending on the workload arising for each type of program or computation. The scheduling can be handled dynamically by the scheduler 910 or can be assisted in part by compiler logic during compilation of program logic configured for execution by the processing cluster array 912. Optionally, different clusters 914A-914N of the processing cluster array 912 can be allocated for processing different types of programs or for performing different types of computations.

The processing cluster array 912 can be configured to perform various types of parallel processing operations. For example, the processing cluster array 912 is configured to perform general-purpose parallel compute operations. For example, the processing cluster array 912 can include logic to execute processing tasks including filtering of video and/or audio data, performing modeling operations, including physics operations, and performing data transformations.

The processing cluster array 912 is configured to perform parallel graphics processing operations. In such examples in which the parallel processor 900 is configured to perform graphics processing operations, the processing cluster array 912 can include additional logic to support the execution of such graphics processing operations, including, but not limited to texture sampling logic to perform texture operations, as well as tessellation logic and other vertex processing logic. Additionally, the processing cluster array 912 can be configured to execute graphics processing related shader programs such as, but not limited to vertex shaders, tessellation shaders, geometry shaders, and pixel shaders. The parallel processing unit 902 can transfer data from system memory via the I/O unit 904 for processing. During processing the transferred data can be stored to on-chip memory (e.g., parallel processor memory 922) during processing, then written back to system memory.

In examples in which the parallel processing unit 902 is used to perform graphics processing, the scheduler 910 may be configured to divide the processing workload into approximately equal sized tasks, to better enable distribution of the graphics processing operations to multiple clusters 914A-914N of the processing cluster array 912. In some of these examples, portions of the processing cluster array 912 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of the clusters 914A-914N may be stored in buffers to allow the intermediate data to be transmitted between clusters 914A-914N for further processing.

During operation, the processing cluster array 912 can receive processing tasks to be executed via the scheduler 910, which receives commands defining processing tasks from front end 908. For graphics processing operations, processing tasks can include indices of data to be processed, e.g., surface (patch) data, primitive data, vertex data, and/or pixel data, as well as state parameters and commands defining how the data is to be processed (e.g., what program is to be executed). The scheduler 910 may be configured to fetch the indices corresponding to the tasks or may receive the indices from the front end 908. The front end 908 can be configured to ensure the processing cluster array 912 is configured to a valid state before the workload specified by incoming command buffers (e.g., batch-buffers, push buffers, etc.) is initiated.

Each of the one or more instances of the parallel processing unit 902 can couple with parallel processor memory 922. The parallel processor memory 922 can be accessed via the memory crossbar 916, which can receive memory requests from the processing cluster array 912 as well as the I/O unit 904. The memory crossbar 916 can access the parallel processor memory 922 via a memory interface 918. The memory interface 918 can include multiple partition units (e.g., partition unit 920A, partition unit 920B, through partition unit 920N) that can each couple to a portion (e.g., memory unit) of parallel processor memory 922. The number of partition units 920A-920N may be configured to be equal to the number of memory units, such that a first partition unit 920A has a corresponding first memory unit 924A, a second partition unit 920B has a corresponding second memory unit 924B, and an Nth partition unit 920N has a corresponding Nth memory unit 924N. In other examples, the number of partition units 920A-920N may not be equal to the number of memory devices.

The memory units 924A-924N can include various types of memory devices, including dynamic random-access memory (DRAM) or graphics random access memory, such as synchronous graphics random access memory (SGRAM), including graphics double data rate (GDDR) memory. Optionally, the memory units 924A-924N may also include 3D stacked memory, including but not limited to high bandwidth memory (HBM). Persons skilled in the art will appreciate that the specific implementation of the memory units 924A-924N can vary and can be selected from one of various conventional designs. Render targets, such as frame buffers or texture maps may be stored across the memory units 924A-924N, allowing partition units 920A-920N to write portions of each render target in parallel to efficiently use the available bandwidth of parallel processor memory 922. In some examples, a local instance of the parallel processor memory 922 may be excluded in favor of a unified memory design that utilizes system memory in conjunction with local cache memory.

Optionally, any one of the clusters 914A-914N of the processing cluster array 912 has the ability to process data that will be written to any of the memory units 924A-924N within parallel processor memory 922. The memory crossbar 916 can be configured to transfer the output of each cluster 914A-914N to any partition unit 920A-920N or to another cluster 914A-914N, which can perform additional processing operations on the output. Each cluster 914A-914N can communicate with the memory interface 918 through the memory crossbar 916 to read from or write to various external memory devices. In one of the examples with the memory crossbar 916 the memory crossbar 916 has a connection to the memory interface 918 to communicate with the I/O unit 904, as well as a connection to a local instance of the parallel processor memory 922, enabling the processing units within the different processing clusters 914A-914N to communicate with system memory or other memory that is not local to the parallel processing unit 902. Generally, the memory crossbar 916 may, for example, be able to use virtual channels to separate traffic streams between the clusters 914A-914N and the partition units 920A-920N.

While a single instance of the parallel processing unit 902 is illustrated within the parallel processor 900, any number of instances of the parallel processing unit 902 can be included. For example, multiple instances of the parallel processing unit 902 can be provided on a single add-in card, or multiple add-in cards can be interconnected. For example, the parallel processor 900 can be an add-in device, such as add-in device 820 of FIG. 8, which may be a graphics card such as a discrete graphics card that includes one or more GPUs, one or more memory devices, and device-to-device or network or fabric interfaces. The different instances of the parallel processing unit 902 can be configured to inter-operate even if the different instances have different numbers of processing cores, different amounts of local parallel processor memory, and/or other configuration differences. Optionally, some instances of the parallel processing unit 902 can include higher precision floating point units relative to other instances. Systems incorporating one or more instances of the parallel processing unit 902 or the parallel processor 900 can be implemented in a variety of configurations and form factors, including but not limited to desktop, laptop, or handheld personal computers, servers, workstations, game consoles, and/or embedded systems. An orchestrator can form composite nodes for workload performance using one or more of: disaggregated processor resources, cache resources, memory resources, storage resources, and networking resources.

In some examples, the parallel processing unit 902 can be partitioned into multiple instances. Those multiple instances can be configured to execute workloads associated with different clients in an isolated manner, enabling a pre-determined quality of service to be provided for each client. For example, each cluster 914A-914N can be compartmentalized and isolated from other clusters, allowing the processing cluster array 912 to be divided into multiple compute partitions or instances. In such configuration, workloads that execute on an isolated partition are protected from faults or errors associated with a different workload that executes on a different partition. The partition units 920A-920N can be configured to enable a dedicated and/or isolated path to memory for the clusters 914A-914N associated with the respective compute partitions. This datapath isolation enables the compute resources within a partition can communicate with one or more assigned memory units 924A-924N without being subjected to inference by the activities of other partitions.

FIG. 9B is a block diagram of a partition unit 920. The partition unit 920 may be an instance of one of the partition units 920A-920N of FIG. 9A. As illustrated, the partition unit 920 includes an L2 cache 921, a frame buffer interface 925, and a ROP 926 (raster operations unit). The L2 cache 921 is a read/write cache that is configured to perform load and store operations received from the memory crossbar 916 and ROP 926. Read misses and urgent write-back requests are output by L2 cache 921 to frame buffer interface 925 for processing. Updates can also be sent to the frame buffer via the frame buffer interface 925 for processing. In some examples the frame buffer interface 925 interfaces with one of the memory units in parallel processor memory, such as the memory units 924A-924N of FIG. 9A (e.g., within parallel processor memory 922). The partition unit 920 may additionally or alternatively also interface with one of the memory units in parallel processor memory via a memory controller (not shown).

In graphics applications, the ROP 926 is a processing unit that performs raster operations such as stencil, z test, blending, and the like. The ROP 926 then outputs processed graphics data that is stored in graphics memory. In some examples the ROP 926 includes or couples with a CODEC 927 that includes compression logic to compress depth or color data that is written to memory or the L2 cache 921 and decompress depth or color data that is read from memory or the L2 cache 921. The compression logic can be lossless compression logic that makes use of one or more of multiple compression algorithms. The type of compression that is performed by the CODEC 927 can vary based on the statistical characteristics of the data to be compressed. For example, in some examples, delta color compression is performed on depth and color data on a per-tile basis. In some examples the CODEC 927 includes compression and decompression logic that can compress and decompress compute data associated with machine learning operations. The CODEC 927 can, for example, compress sparse matrix data for sparse machine learning operations. The CODEC 927 can also compress sparse matrix data that is encoded in a sparse matrix format (e.g., coordinate list encoding (COO), compressed sparse row (CSR), compress sparse column (CSC), etc.) to generate compressed and encoded sparse matrix data. The compressed and encoded sparse matrix data can be decompressed and/or decoded before being processed by processing elements or the processing elements can be configured to consume compressed, encoded, or compressed and encoded data for processing.

The ROP 926 may be included within each processing cluster (e.g., cluster 914A-914N of FIG. 9A) instead of within the partition unit 920. In such example, read and write requests for pixel data are transmitted over the memory crossbar 916 instead of pixel fragment data. The processed graphics data may be displayed on a display device, such as one of the one or more display device(s) 810A-810B of FIG. 8, routed for further processing by the processor(s) 802, or routed for further processing by one of the processing entities within the parallel processor 900 of FIG. 9A.

FIG. 9C is a block diagram of a processing cluster 914 within a parallel processing unit. For example, the processing cluster is an instance of one of the processing clusters 914A-914N of FIG. 9A. The processing cluster 914 can be configured to execute many threads in parallel, where the term “thread” refers to an instance of a particular program executing on a particular set of input data. Optionally, single-instruction, multiple-data (SIMD) instruction issue techniques may be used to support parallel execution of a large number of threads without providing multiple independent instruction units. Alternatively, single-instruction, multiple-thread (SIMT) techniques may be used to support parallel execution of a large number of generally synchronized threads, using a common instruction unit configured to issue instructions to a set of processing engines within each one of the processing clusters. Unlike a SIMD execution regime, where all processing engines typically execute identical instructions, SIMT execution allows different threads to follow divergent execution paths more readily through a given thread program. Persons skilled in the art will understand that a SIMD processing regime represents a functional subset of a SIMT processing regime.

Operation of the processing cluster 914 can be controlled via a pipeline manager 932 that distributes processing tasks to SIMT parallel processors. The pipeline manager 932 receives instructions from the scheduler 910 of FIG. 9A and manages execution of those instructions via a graphics multiprocessor 934 and/or a texture unit 936. The illustrated graphics multiprocessor 934 is an exemplary instance of a SIMT parallel processor. However, various types of SIMT parallel processors of differing architectures may be included within the processing cluster 914. One or more instances of the graphics multiprocessor 934 can be included within a processing cluster 914. The graphics multiprocessor 934 can process data and a data crossbar 940 can be used to distribute the processed data to one of multiple possible destinations, including other shader units. The pipeline manager 932 can facilitate the distribution of processed data by specifying destinations for processed data to be distributed via the data crossbar 940.

Each graphics multiprocessor 934 within the processing cluster 914 can include an identical set of functional execution logic (e.g., arithmetic logic units, load-store units, etc.). The functional execution logic can be configured in a pipelined manner in which new instructions can be issued before previous instructions are complete. The functional execution logic supports a variety of operations including integer and floating-point arithmetic, comparison operations, Boolean operations, bit-shifting, and computation of various algebraic functions. The same functional-unit hardware could be leveraged to perform different operations and any combination of functional units may be present.

The instructions transmitted to the processing cluster 914 constitute a thread. A set of threads executing across the set of parallel processing engines is a thread group. A thread group executes the same program on different input data. Each thread within a thread group can be assigned to a different processing engine within a graphics multiprocessor 934. A thread group may include fewer threads than the number of processing engines within the graphics multiprocessor 934. When a thread group includes fewer threads than the number of processing engines, one or more of the processing engines may be idle during cycles in which that thread group is being processed. A thread group may also include more threads than the number of processing engines within the graphics multiprocessor 934. When the thread group includes more threads than the number of processing engines within the graphics multiprocessor 934, processing can be performed over consecutive clock cycles. Optionally, multiple thread groups can be executed concurrently on the graphics multiprocessor 934.

The graphics multiprocessor 934 may include an internal cache memory to perform load and store operations. Optionally, the graphics multiprocessor 934 can forego an internal cache and use a cache memory (e.g., level 1 (L1) cache 948) within the processing cluster 914. Each graphics multiprocessor 934 also has access to level 2 (L2) caches within the partition units (e.g., partition units 920A-920N of FIG. 9A) that are shared among all processing clusters 914 and may be used to transfer data between threads. The graphics multiprocessor 934 may also access off-chip global memory, which can include one or more of local parallel processor memory and/or system memory. Any memory external to the parallel processing unit 902 may be used as global memory. Embodiments in which the processing cluster 914 includes multiple instances of the graphics multiprocessor 934 can share common instructions and data, which may be stored in the L1 cache 948.

Each processing cluster 914 may include an MMU 945 (memory management unit) that is configured to map virtual addresses into physical addresses. In other examples, one or more instances of the MMU 945 may reside within the memory interface 918 of FIG. 9A. The MMU 945 includes a set of page table entries (PTEs) used to map a virtual address to a physical address of a tile and optionally a cache line index. The MMU 945 may include address translation lookaside buffers (TLB) or caches that may reside within the graphics multiprocessor 934 or the L1 cache 948 of processing cluster 914. The physical address is processed to distribute surface data access locality to allow efficient request interleaving among partition units. The cache line index may be used to determine whether a request for a cache line is a hit or miss.

In graphics and computing applications, a processing cluster 914 may be configured such that each graphics multiprocessor 934 is coupled to a texture unit 936 for performing texture mapping operations, e.g., determining texture sample positions, reading texture data, and filtering the texture data. Texture data is read from an internal texture L1 cache (not shown) or in some examples from the L1 cache within graphics multiprocessor 934 and is fetched from an L2 cache, local parallel processor memory, or system memory, as needed. Each graphics multiprocessor 934 outputs processed tasks to the data crossbar 940 to provide the processed task to another processing cluster 914 for further processing or to store the processed task in an L2 cache, local parallel processor memory, or system memory via the memory crossbar 916. A preROP 942 (pre-raster operations unit) is configured to receive data from graphics multiprocessor 934, direct data to ROP units, which may be located with partition units as described herein (e.g., partition units 920A-920N of FIG. 9A). The preROP 942 unit can perform optimizations for color blending, organize pixel color data, and perform address translations.

It will be appreciated that the core architecture described herein is illustrative and that variations and modifications are possible. Any number of processing units, e.g., graphics multiprocessor 934, texture units 936, preROPs 942, etc., may be included within a processing cluster 914. Further, while only one processing cluster 914 is shown, a parallel processing unit as described herein may include any number of instances of the processing cluster 914. Optionally, each processing cluster 914 can be configured to operate independently of other processing clusters 914 using separate and distinct processing units, L1 caches, L2 caches, etc.

FIG. 9D shows an example of the graphics multiprocessor 934 in which the graphics multiprocessor 934 couples with the pipeline manager 932 of the processing cluster 914. The graphics multiprocessor 934 has an execution pipeline including but not limited to an instruction cache 952, an instruction unit 954, an address mapping unit 956, a register file 958, one or more general purpose graphics processing unit (GPGPU) cores 962, and one or more load/store units 966. The GPGPU cores 962 and load/store units 966 are coupled with cache memory 972 and shared memory 970 via a memory and cache interconnect 968. The graphics multiprocessor 934 may additionally include tensor and/or ray-tracing cores 963 that include hardware logic to accelerate matrix and/or ray-tracing operations.

The instruction cache 952 may receive a stream of instructions to execute from the pipeline manager 932. The instructions are cached in the instruction cache 952 and dispatched for execution by the instruction unit 954. The instruction unit 954 can dispatch instructions as thread groups (e.g., warps), with each thread of the thread group assigned to a different execution unit within GPGPU core 962. An instruction can access any of a local, shared, or global address space by specifying an address within a unified address space. The address mapping unit 956 can be used to translate addresses in the unified address space into a distinct memory address that can be accessed by the load/store units 966.

The register file 958 provides a set of registers for the functional units of the graphics multiprocessor 934. The register file 958 provides temporary storage for operands connected to the data paths of the functional units (e.g., GPGPU cores 962, load/store units 966) of the graphics multiprocessor 934. The register file 958 may be divided between each of the functional units such that each functional unit is allocated a dedicated portion of the register file 958. For example, the register file 958 may be divided between the different warps being executed by the graphics multiprocessor 934.

The GPGPU cores 962 can each include floating point units (FPUs) and/or integer arithmetic logic units (ALUs) that are used to execute instructions of the graphics multiprocessor 934. In some implementations, the GPGPU cores 962 can include hardware logic that may otherwise reside within the tensor and/or ray-tracing cores 963. The GPGPU cores 962 can be similar in architecture or can differ in architecture. For example and in some examples, a first portion of the GPGPU cores 962 include a single precision FPU and an integer ALU while a second portion of the GPGPU cores include a double precision FPU. Optionally, the FPUs can implement the IEEE 754-2008 standard for floating point arithmetic or enable variable precision floating point arithmetic. The graphics multiprocessor 934 can additionally include one or more fixed function or special function units to perform specific functions such as copy rectangle or pixel blending operations. One or more of the GPGPU cores can also include fixed or special function logic.

The GPGPU cores 962 may include SIMD logic capable of performing a single instruction on multiple sets of data. Optionally, GPGPU cores 962 can physically execute SIMD4, SIMD8, and SIMD16 instructions and logically execute SIMD1, SIMD2, and SIMD32 instructions. The SIMD instructions for the GPGPU cores can be generated at compile time by a shader compiler or automatically generated when executing programs written and compiled for single program multiple data (SPMD) or SIMT architectures. Multiple threads of a program configured for the SIMT execution model can be executed via a single SIMD instruction. For example and in some examples, eight SIMT threads that perform the same or similar operations can be executed in parallel via a single SIMD8 logic unit.

The memory and cache interconnect 968 is an interconnect network that connects each of the functional units of the graphics multiprocessor 934 to the register file 958 and to the shared memory 970. For example, the memory and cache interconnect 968 is a crossbar interconnect that allows the load/store unit 966 to implement load and store operations between the shared memory 970 and the register file 958. The register file 958 can operate at the same frequency as the GPGPU cores 962, thus data transfer between the GPGPU cores 962 and the register file 958 is very low latency. The shared memory 970 can be used to enable communication between threads that execute on the functional units within the graphics multiprocessor 934. The cache memory 972 can be used as a data cache for example, to cache texture data communicated between the functional units and the texture unit 936. The shared memory 970 can also be used as a program managed cached. The shared memory 970 and the cache memory 972 can couple with the data crossbar 940 to enable communication with other components of the processing cluster. Threads executing on the GPGPU cores 962 can programmatically store data within the shared memory in addition to the automatically cached data that is stored within the cache memory 972.

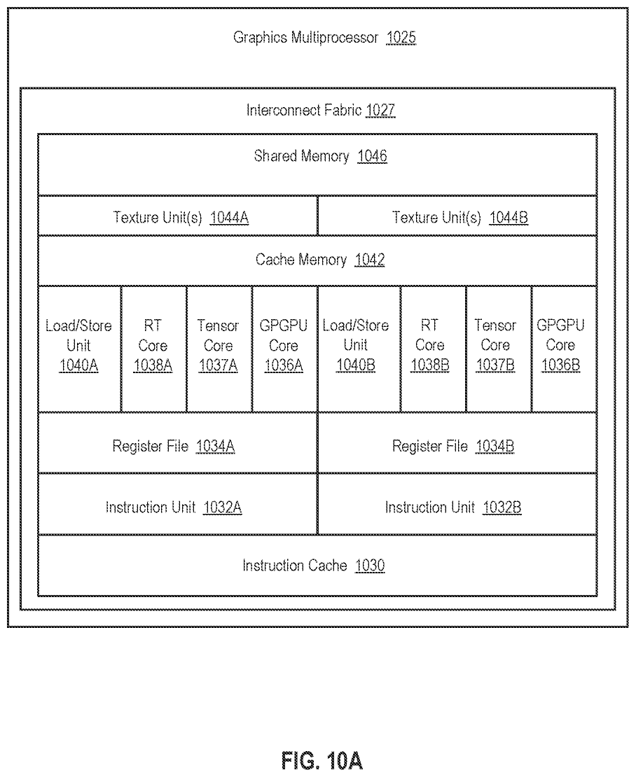

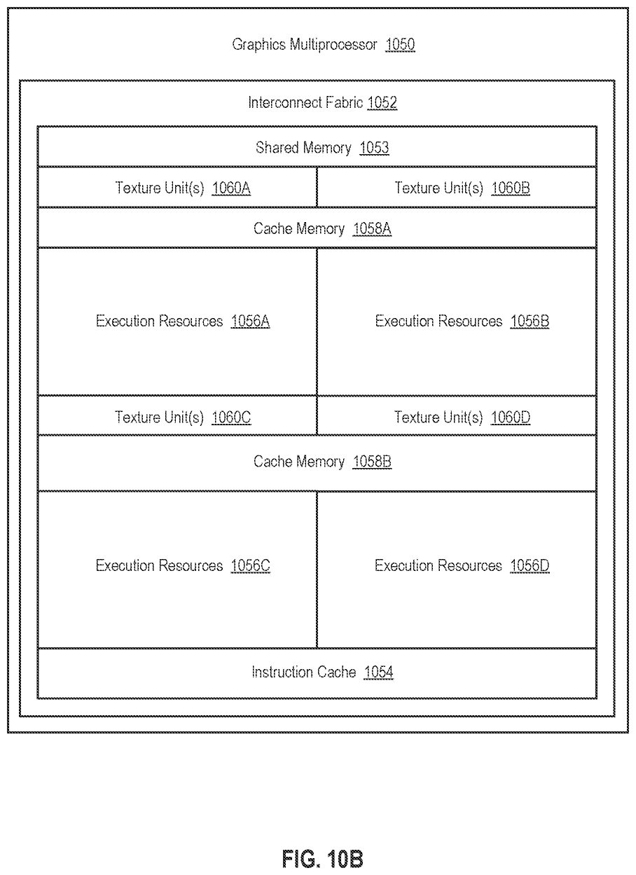

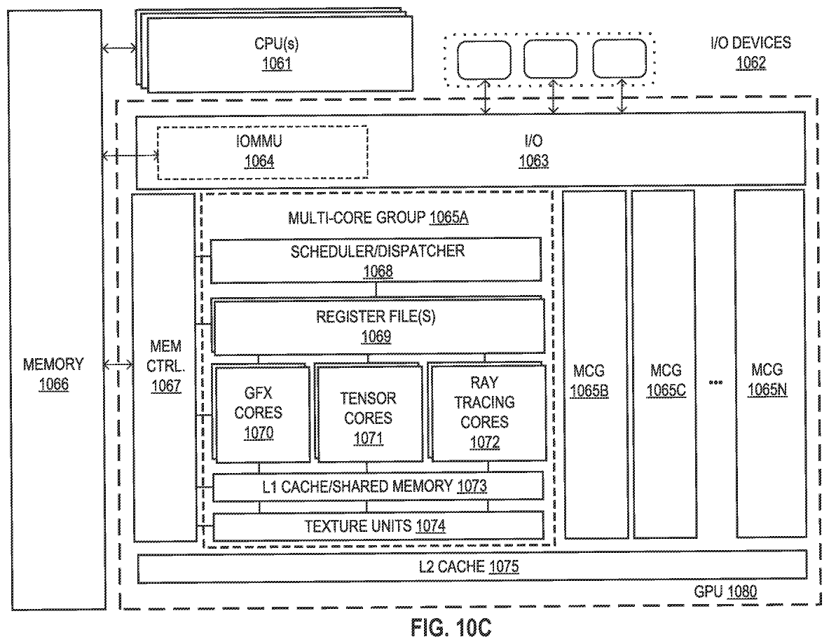

FIGS. 10A-10C illustrate additional graphics multiprocessors, according to examples. FIG. 10A-10B illustrate graphics multiprocessors 1025, 1050, which are related to the graphics multiprocessor 934 of FIG. 9C and may be used in place of one of those. Therefore, the disclosure of any features in combination with the graphics multiprocessor 934 herein also discloses a corresponding combination with the graphics multiprocessor(s) 1025, 1050, but is not limited to such. FIG. 10C illustrates a graphics processing unit (GPU) 1080 which includes dedicated sets of graphics processing resources arranged into multi-core groups 1065A-1065N, which correspond to the graphics multiprocessors 1025, 1050. The illustrated graphics multiprocessors 1025, 1050 and the multi-core groups 1065A-1065N can be streaming multiprocessors (SM) capable of simultaneous execution of a large number of execution threads.

The graphics multiprocessor 1025 of FIG. 10A includes multiple additional instances of execution resource units relative to the graphics multiprocessor 934 of FIG. 9D. For example, the graphics multiprocessor 1025 can include multiple instances of the instruction unit 1032A-1032B, register file 1034A-1034B, and texture unit(s) 1044A-1044B. The graphics multiprocessor 1025 also includes multiple sets of graphics or compute execution units (e.g., GPGPU core 1036A-1036B, tensor core 1037A-1037B, ray-tracing core 1038A-1038B) and multiple sets of load/store units 1040A-1040B. The execution resource units have a common instruction cache 1030, texture and/or data cache memory 1042, and shared memory 1046.

The various components can communicate via an interconnect fabric 1027. The interconnect fabric 1027 may include one or more crossbar switches to enable communication between the various components of the graphics multiprocessor 1025. The interconnect fabric 1027 may be a separate, high-speed network fabric layer upon which each component of the graphics multiprocessor 1025 is stacked. The components of the graphics multiprocessor 1025 communicate with remote components via the interconnect fabric 1027. For example, the cores 1036A-1036B, 1037A-1037B, and 1038A-1038B can each communicate with shared memory 1046 via the interconnect fabric 1027. The interconnect fabric 1027 can arbitrate communication within the graphics multiprocessor 1025 to ensure a fair bandwidth allocation between components.

The graphics multiprocessor 1050 of FIG. 10B includes multiple sets of execution resources 1056A-1056D, where each set of execution resource includes multiple instruction units, register files, GPGPU cores, and load store units, as illustrated in FIG. 9D and FIG. 10A. The execution resources 1056A-1056D can work in concert with texture unit(s) 1060A-1060D for texture operations, while sharing an instruction cache 1054, and shared memory 1053. For example, the execution resources 1056A-1056D can share an instruction cache 1054 and shared memory 1053, as well as multiple instances of a texture and/or data cache memory 1058A-1058B. The various components can communicate via an interconnect fabric 1052 similar to the interconnect fabric 1027 of FIG. 10A.

Persons skilled in the art will understand that the architecture described in FIG. 1, 9A-9D, and 10A-10B are descriptive and not limiting as to the scope of the present examples. Thus, the techniques described herein may be implemented on any properly configured processing unit, including, without limitation, one or more mobile application processors, one or more desktop or server central processing units (CPUs) including multi-core CPUs, one or more parallel processing units, such as the parallel processing unit 902 of FIG. 9A, as well as one or more graphics processors or special purpose processing units, without departure from the scope of the examples described herein.

The parallel processor or GPGPU as described herein may be communicatively coupled to host/processor cores to accelerate graphics operations, machine-learning operations, pattern analysis operations, and various general-purpose GPU (GPGPU) functions. The GPU may be communicatively coupled to the host processor/cores over a bus or other interconnect (e.g., a high-speed interconnect such as PCIe, NVLink, or other known protocols, standardized protocols, or proprietary protocols). In other examples, the GPU may be integrated on the same package or chip as the cores and communicatively coupled to the cores over an internal processor bus/interconnect (e.g., internal to the package or chip). Regardless of the manner in which the GPU is connected, the processor cores may allocate work to the GPU in the form of sequences of commands/instructions contained in a work descriptor. The GPU then uses dedicated circuitry/logic for efficiently processing these commands/instructions.

FIG. 10C illustrates a graphics processing unit (GPU) 1080 which includes dedicated sets of graphics processing resources arranged into multi-core groups 1065A-1065N. While the details of only a single multi-core group 1065A are provided, it will be appreciated that the other multi-core groups 1065B-1065N may be equipped with the same or similar sets of graphics processing resources. Details described with respect to the multi-core groups 1065A-1065N may also apply to any graphics multiprocessor 934, 1025, 1050 described herein.

As illustrated, a multi-core group 1065A may include a set of graphics cores 1070, a set of tensor cores 1071, and a set of ray tracing cores 1072. A scheduler/dispatcher 1068 schedules and dispatches the graphics threads for execution on the various cores 1070, 1071, 1072. A set of register files 1069 store operand values used by the cores 1070, 1071, 1072 when executing the graphics threads. These may include, for example, integer registers for storing integer values, floating point registers for storing floating point values, vector registers for storing packed data elements (integer and/or floating-point data elements) and tile registers for storing tensor/matrix values. The tile registers may be implemented as combined sets of vector registers.

One or more combined level 1 (L1) caches and shared memory units 1073 store graphics data such as texture data, vertex data, pixel data, ray data, bounding volume data, etc., locally within each multi-core group 1065A. One or more texture units 1074 can also be used to perform texturing operations, such as texture mapping and sampling. A Level 2 (L2) cache 1075 shared by all or a subset of the multi-core groups 1065A-1065N stores graphics data and/or instructions for multiple concurrent graphics threads. As illustrated, the L2 cache 1075 may be shared across a plurality of multi-core groups 1065A-1065N. One or more memory controllers 1067 couple the GPU 1080 to a memory 1066 which may be a system memory (e.g., DRAM) and/or a dedicated graphics memory (e.g., GDDR6 memory).

Input/output (I/O) circuitry 1063 couples the GPU 1080 to one or more I/O devices 1062 such as digital signal processors (DSPs), network controllers, or user input devices. An on-chip interconnect may be used to couple the I/O devices 1062 to the GPU 1080 and memory 1066. One or more I/O memory management units (IOMMUs) 1064 of the I/O circuitry 1063 couple the I/O devices 1062 directly to the system memory 1066. Optionally, the IOMMU 1064 manages multiple sets of page tables to map virtual addresses to physical addresses in system memory 1066. The I/O devices 1062, CPU(s) 1061, and GPU(s) 1080 may then share the same virtual address space.

In one implementation of the IOMMU 1064, the IOMMU 1064 supports virtualization. In this case, it may manage a first set of page tables to map guest/graphics virtual addresses to guest/graphics physical addresses and a second set of page tables to map the guest/graphics physical addresses to system/host physical addresses (e.g., within system memory 1066). The base addresses of each of the first and second sets of page tables may be stored in control registers and swapped out on a context switch (e.g., so that the new context is provided with access to the relevant set of page tables). While not illustrated in FIG. 10C, each of the cores 1070, 1071, 1072 and/or multi-core groups 1065A-1065N may include translation lookaside buffers (TLBs) to cache guest virtual to guest physical translations, guest physical to host physical translations, and guest virtual to host physical translations.

The CPU(s) 1061, GPUs 1080, and I/O devices 1062 may be integrated on a single semiconductor chip and/or chip package. The illustrated memory 1066 may be integrated on the same chip or may be coupled to the memory controllers 1067 via an off-chip interface. In one implementation, the memory 1066 comprises GDDR6 memory which shares the same virtual address space as other physical system-level memories, although the underlying principles described herein are not limited to this specific implementation.

The tensor cores 1071 may include a plurality of execution units specifically designed to perform matrix operations, which are the fundamental compute operation used to perform deep learning operations. For example, simultaneous matrix multiplication operations may be used for neural network training and inferencing. The tensor cores 1071 may perform matrix processing using a variety of operand precisions including single precision floating-point (e.g., 32 bits), half-precision floating point (e.g., 16 bits), integer words (16 bits), bytes (8 bits), and half-bytes (4 bits). For example, a neural network implementation extracts features of each rendered scene, potentially combining details from multiple frames, to construct a high-quality final image.

In deep learning implementations, parallel matrix multiplication work may be scheduled for execution on the tensor cores 1071. The training of neural networks, in particular, requires a significant number of matrix dot product operations. In order to process an inner-product formulation of an N×N×N matrix multiply, the tensor cores 1071 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 1071 to ensure that the most efficient precision is used for different workloads (e.g., such as inferencing workloads which can tolerate quantization to bytes and half-bytes). Supported formats additionally include 64-bit floating point (FP64) and non-IEEE floating point formats such as the bfloat16 format (e.g., Brain floating point), a 16-bit floating point format with one sign bit, eight exponent bits, and eight significand bits, of which seven are explicitly stored. One example includes support for a reduced precision tensor-float (TF32) mode, which performs computations using the range of FP32 (8-bits) and the precision of FP16 (10-bits). Reduced precision TF32 operations can be performed on FP32 inputs and produce FP32 outputs at higher performance relative to FP32 and increased precision relative to FP16. In some examples, one or more 8-bit floating point formats (FP8) are supported.

In some examples the tensor cores 1071 support a sparse mode of operation for matrices in which the vast majority of values are zero. The tensor cores 1071 include support for sparse input matrices that are encoded in a sparse matrix representation (e.g., coordinate list encoding (COO), compressed sparse row (CSR), compress sparse column (CSC), etc.). The tensor cores 1071 also include support for compressed sparse matrix representations in the event that the sparse matrix representation may be further compressed. Compressed, encoded, and/or compressed and encoded matrix data, along with associated compression and/or encoding metadata, can be read by the tensor cores 1071 and the non-zero values can be extracted. For example, for a given input matrix A, a non-zero value can be loaded from the compressed and/or encoded representation of at least a portion of matrix A. Based on the location in matrix A for the non-zero value, which may be determined from index or coordinate metadata associated with the non-zero value, a corresponding value in input matrix B may be loaded. Depending on the operation to be performed (e.g., multiply), the load of the value from input matrix B may be bypassed if the corresponding value is a zero value. In some examples, the pairings of values for certain operations, such as multiply operations, may be pre-scanned by scheduler logic and only operations between non-zero inputs are scheduled. Depending on the dimensions of matrix A and matrix B and the operation to be performed, output matrix C may be dense or sparse. Where output matrix C is sparse and depending on the configuration of the tensor cores 1071, output matrix C may be output in a compressed format, a sparse encoding, or a compressed sparse encoding.

The ray tracing cores 1072 may accelerate ray tracing operations for both real-time ray tracing and non-real-time ray tracing implementations. In particular, the ray tracing cores 1072 may include ray traversal/intersection circuitry for performing ray traversal using bounding volume hierarchies (BVHs) and identifying intersections between rays and primitives enclosed within the BVH volumes. The ray tracing cores 1072 may also include circuitry for performing depth testing and culling (e.g., using a Z buffer or similar arrangement). In one implementation, the ray tracing cores 1072 perform traversal and intersection operations in concert with the image denoising techniques described herein, at least a portion of which may be executed on the tensor cores 1071. For example, the tensor cores 1071 may implement a deep learning neural network to perform denoising of frames generated by the ray tracing cores 1072. However, the CPU(s) 1061, graphics cores 1070, and/or ray tracing cores 1072 may also implement all or a portion of the denoising and/or deep learning algorithms.

In addition, as described above, a distributed approach to denoising may be employed in which the GPU 1080 is in a computing device coupled to other computing devices over a network or high-speed interconnect. In this distributed approach, the interconnected computing devices may share neural network learning/training data to improve the speed with which the overall system learns to perform denoising for different types of image frames and/or different graphics applications.

The ray tracing cores 1072 may process all BVH traversal and/or ray-primitive intersections, saving the graphics cores 1070 from being overloaded with thousands of instructions per ray. For example, each ray tracing core 1072 includes a first set of specialized circuitry for performing bounding box tests (e.g., for traversal operations) and/or a second set of specialized circuitry for performing the ray-triangle intersection tests (e.g., intersecting rays which have been traversed). Thus, for example, the multi-core group 1065A can simply launch a ray probe, and the ray tracing cores 1072 independently perform ray traversal and intersection and return hit data (e.g., a hit, no hit, multiple hits, etc.) to the thread context. The other cores 1070, 1071 are freed to perform other graphics or compute work while the ray tracing cores 1072 perform the traversal and intersection operations.

Optionally, each ray tracing core 1072 may include a traversal unit to perform BVH testing operations and/or an intersection unit which performs ray-primitive intersection tests. The intersection unit generates a “hit”, “no hit”, or “multiple hit” response, which it provides to the appropriate thread. During the traversal and intersection operations, the execution resources of the other cores (e.g., graphics cores 1070 and tensor cores 1071) are freed to perform other forms of graphics work.

In some examples described below, a hybrid rasterization/ray tracing approach is used in which work is distributed between the graphics cores 1070 and ray tracing cores 1072.

The ray tracing cores 1072 (and/or other cores 1070, 1071) may include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 1072, graphics cores 1070 and tensor cores 1071 is Vulkan API (e.g., Vulkan version 1.1.85 and later). Note, however, that the underlying principles described herein are not limited to any particular ray tracing ISA.

In general, the various cores 1072, 1071, 1070 may support a ray tracing instruction set that includes instructions/functions for one or more of ray generation, closest hit, any hit, ray-primitive intersection, per-primitive and hierarchical bounding box construction, miss, visit, and exceptions. More specifically, some examples include ray tracing instructions to perform one or more of the following functions:
Ray Generation—Ray generation instructions may be executed for each pixel, sample, or other user-defined work assignment.
Closest Hit— A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per-primitive Bounding box Construction—This instruction builds a bounding box around a given primitive or group of primitives (e.g., when building a new BVH or other acceleration data structure).
Miss—Indicates that a ray misses all geometry within a scene, or specified region of a scene.
Visit—Indicates the child volumes a ray will traverse.
Exceptions—Includes various types of exception handlers (e.g., invoked for various error conditions).

In some examples the ray tracing cores 1072 may be adapted to accelerate general-purpose compute operations that can be accelerated using computational techniques that are analogous to ray intersection tests. A compute framework can be provided that enables shader programs to be compiled into low level instructions and/or primitives that perform general-purpose compute operations via the ray tracing cores. Exemplary computational problems that can benefit from compute operations performed on the ray tracing cores 1072 include computations involving beam, wave, ray, or particle propagation within a coordinate space. Interactions associated with that propagation can be computed relative to a geometry or mesh within the coordinate space. For example, computations associated with electromagnetic signal propagation through an environment can be accelerated via the use of instructions or primitives that are executed via the ray tracing cores. Diffraction and reflection of the signals by objects in the environment can be computed as direct ray-tracing analogies.

Ray tracing cores 1072 can also be used to perform computations that are not directly analogous to ray tracing. For example, mesh projection, mesh refinement, and volume sampling computations can be accelerated using the ray tracing cores 1072. Generic coordinate space calculations, such as nearest neighbor calculations can also be performed. For example, the set of points near a given point can be discovered by defining a bounding box in the coordinate space around the point. BVH and ray probe logic within the ray tracing cores 1072 can then be used to determine the set of point intersections within the bounding box. The intersections constitute the origin point and the nearest neighbors to that origin point. Computations that are performed using the ray tracing cores 1072 can be performed in parallel with computations performed on the graphics cores 1072 and tensor cores 1071. A shader compiler can be configured to compile a compute shader or other general-purpose graphics processing program into low level primitives that can be parallelized across the graphics cores 1070, tensor cores 1071, and ray tracing cores 1072.

Building larger and larger silicon dies is challenging for a variety of reasons. As silicon dies become larger, manufacturing yields become smaller and process technology requirements for different components may diverge. On the other hand, in order to have a high-performance system, key components should be interconnected by high speed, high bandwidth, low latency interfaces. These contradicting needs pose a challenge to high performance chip development.

Embodiments described herein provide techniques to disaggregate an architecture of a system on a chip integrated circuit into multiple distinct chiplets that can be packaged onto a common chassis. In some examples, a graphics processing unit or parallel processor is composed from diverse silicon chiplets that are separately manufactured. A chiplet is an at least partially packaged integrated circuit that includes distinct units of logic that can be assembled with other chiplets into a larger package. A diverse set of chiplets with different IP core logic can be assembled into a single device. Additionally, the chiplets can be integrated into a base die or base chiplet using active interposer technology. The concepts described herein enable the interconnection and communication between the different forms of IP within the GPU. The development of IPs on different process may be mixed. This avoids the complexity of converging multiple IPs, especially on a large SoC with several flavors IPs, to the same process.

Enabling the use of multiple process technologies improves the time to market and provides a cost-effective way to create multiple product SKUs. For customers, this means getting products that are more tailored to their requirements in a cost effective and timely manner. Additionally, the disaggregated IPs are more amenable to being power gated independently, components that are not in use on a given workload can be powered off, reducing overall power consumption.

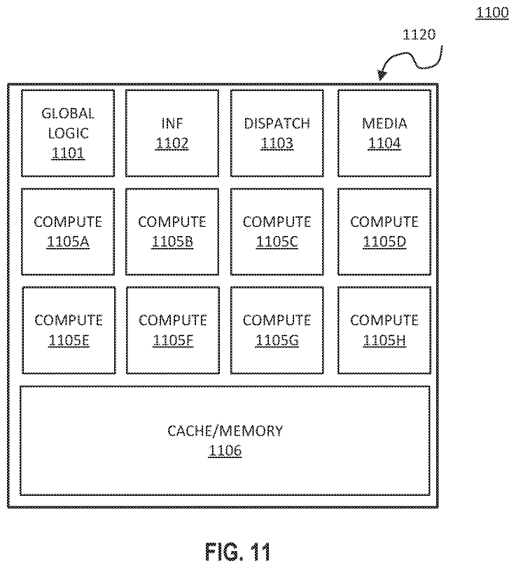

FIG. 11 shows a parallel compute system 1100, according to some examples. In some examples the parallel compute system 1100 includes a parallel processor 1120, which can be a graphics processor or compute accelerator as described herein. The parallel processor 1120 includes a global logic unit 1101, an interface 1102, a thread dispatcher 1103, a media unit 1104, a set of compute units 1105A-1105H, and a cache/memory units 1106. The global logic unit 1101, in some examples, includes global functionality for the parallel processor 1120, including device configuration registers, global schedulers, power management logic, and the like. The interface 1102 can include a front-end interface for the parallel processor 1120. The thread dispatcher 1103 can receive workloads from the interface 1102 and dispatch threads for the workload to the compute units 1105A-1105H. If the workload includes any media operations, at least a portion of those operations can be performed by the media unit 1104. The media unit can also offload some operations to the compute units 1105A-1105H. The cache/memory units 1106 can include cache memory (e.g., L3 cache) and local memory (e.g., HBM, GDDR) for the parallel processor 1120.

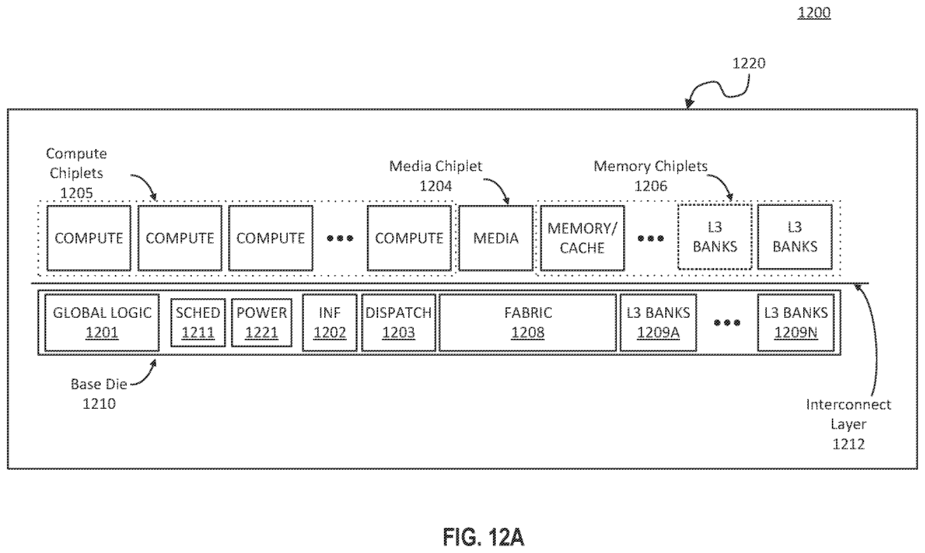

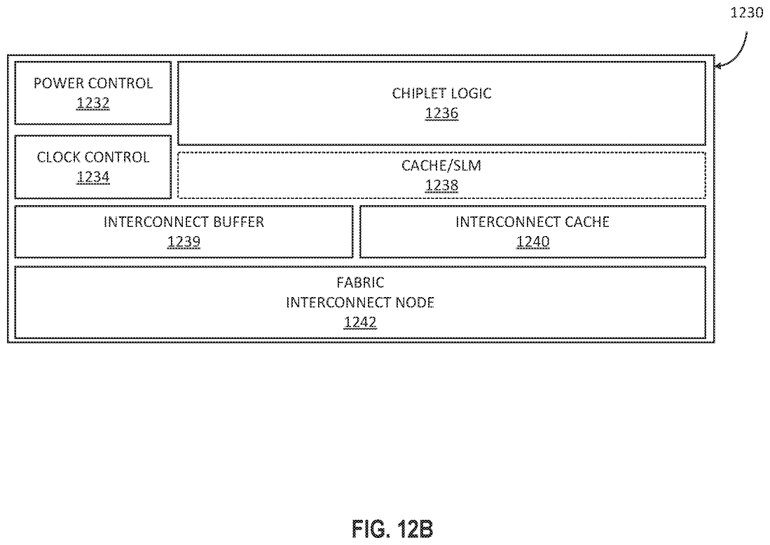

FIGS. 12A-12B illustrate a hybrid logical/physical view of a disaggregated parallel processor, according to examples described herein. FIG. 12A illustrates a disaggregated parallel compute system 1200. FIG. 12B illustrates a chiplet 1230 of the disaggregated parallel compute system 1200.

As shown in FIG. 12A, a disaggregated compute system 1200 can include a parallel processor 1220 in which the various components of the parallel processor SOC are distributed across multiple chiplets. Each chiplet can be a distinct IP core that is independently designed and configured to communicate with other chiplets via one or more common interfaces. The chiplets include but are not limited to compute chiplets 1205, a media chiplet 1204, and memory chiplets 1206. Each chiplet can be separately manufactured using different process technologies. For example, compute chiplets 1205 may be manufactured using the smallest or most advanced process technology available at the time of fabrication, while memory chiplets 1206 or other chiplets (e.g., I/O, networking, etc.) may be manufactured using a larger or less advanced process technologies.

The various chiplets can be bonded to a base die 1210 and configured to communicate with each other and logic within the base die 1210 via an interconnect layer 1212. In some examples, the base die 1210 can include global logic 1201, which can include scheduler 1211 and power management 1221 logic units, an interface 1202, a dispatch unit 1203, and an interconnect fabric module 1208 coupled with or integrated with one or more L3 cache banks 1209A-1209N. The interconnect fabric 1208 can be an inter-chiplet fabric that is integrated into the base die 1210. Logic chiplets can use the fabric 1208 to relay messages between the various chiplets. Additionally, L3 cache banks 1209A-1209N in the base die and/or L3 cache banks within the memory chiplets 1206 can cache data read from and transmitted to DRAM chiplets within the memory chiplets 1206 and to system memory of a host.

In some examples the global logic 1201 is a microcontroller that can execute firmware to perform scheduler 1211 and power management 1221 functionality for the parallel processor 1220. The microcontroller that executes the global logic can be tailored for the target use case of the parallel processor 1220. The scheduler 1211 can perform global scheduling operations for the parallel processor 1220. The power management 1221 functionality can be used to enable or disable individual chiplets within the parallel processor when those chiplets are not in use.

The various chiplets of the parallel processor 1220 can be designed to perform specific functionality that, in existing designs, would be integrated into a single die. A set of compute chiplets 1205 can include clusters of compute units (e.g., execution units, streaming multiprocessors, etc.) that include programmable logic to execute compute or graphics shader instructions. A media chiplet 1204 can include hardware logic to accelerate media encode and decode operations. Memory chiplets 1206 can include volatile memory (e.g., DRAM) and one or more SRAM cache memory banks (e.g., L3 banks).

As shown in FIG. 12B, each chiplet 1230 can include common components and application specific components. Chiplet logic 1236 within the chiplet 1230 can include the specific components of the chiplet, such as an array of streaming multiprocessors, compute units, or execution units described herein. The chiplet logic 1236 can couple with an optional cache or shared local memory 1238 or can include a cache or shared local memory within the chiplet logic 1236. The chiplet 1230 can include a fabric interconnect node 1242 that receives commands via the inter-chiplet fabric. Commands and data received via the fabric interconnect node 1242 can be stored temporarily within an interconnect buffer 1239. Data transmitted to and received from the fabric interconnect node 1242 can be stored in an interconnect cache 1240. Power control 1232 and clock control 1234 logic can also be included within the chiplet. The power control 1232 and clock control 1234 logic can receive configuration commands via the fabric can configure dynamic voltage and frequency scaling for the chiplet 1230. In some examples, each chiplet can have an independent clock domain and power domain and can be clock gated and power gated independently of other chiplets.

At least a portion of the components within the illustrated chiplet 1230 can also be included within logic embedded within the base die 1210 of FIG. 12A. For example, logic within the base die that communicates with the fabric can include a version of the fabric interconnect node 1242. Base die logic that can be independently clock or power gated can include a version of the power control 1232 and/or clock control 1234 logic.

Thus, while various examples described herein use the term SOC to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various examples of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems, the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).”

### Example Core Architectures—In-Order and Out-of-Order Core Block Diagram

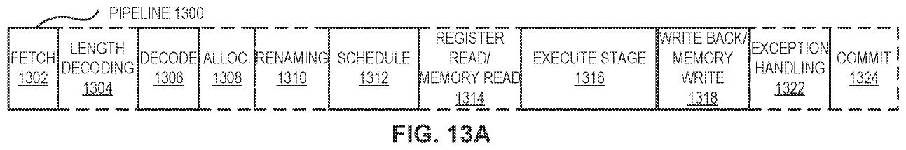

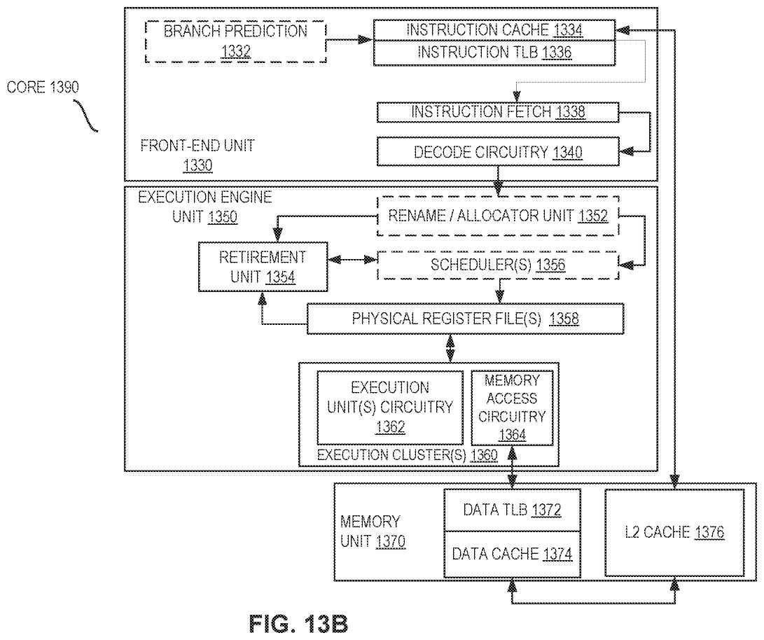

FIG. 13A is a block diagram illustrating both an example in-order pipeline and an example register renaming, out-of-order issue/execution pipeline according to examples. FIG. 13B is a block diagram illustrating both an example in-order architecture core and an example register renaming, out-of-order issue/execution architecture core to be included in a processor according to examples. The solid lined boxes in FIGS. 13A-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 13A, a processor pipeline 1300 includes a fetch stage 1302, an optional length decoding stage 1304, a decode stage 1306, an optional allocation (Alloc) stage 1308, an optional renaming stage 1310, a schedule (also known as a dispatch or issue) stage 1312, an optional register read/memory read stage 1314, an execute stage 1316, a write back/memory write stage 1318, an optional exception handling stage 1322, and an optional commit stage 1324. One or more operations can be performed in each of these processor pipeline stages. For example, during the fetch stage 1302, one or more instructions are fetched from instruction memory, and during the decode stage 1306, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 1306 and the register read/memory read stage 1314 may be combined into one pipeline stage. In some examples, during the execute stage 1316, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 13B may implement the pipeline 1300 as follows: 1) the instruction fetch circuitry 1338 performs the fetch and length decoding stages 1302 and 1304; 2) the decode circuitry 1340 performs the decode stage 1306; 3) the rename/allocator unit circuitry 1352 performs the allocation stage 1308 and renaming stage 1310; 4) the scheduler(s) circuitry 1356 performs the schedule stage 1312; 5) the physical register file(s) circuitry 1358 and the memory unit circuitry 1370 perform the register read/memory read stage 1314; the execution cluster(s) 1360 perform the execute stage 1316; 6) the memory unit circuitry 1370 and the physical register file(s) circuitry 1358 perform the write back/memory write stage 1318; 7) various circuitry may be involved in the exception handling stage 1322; and 8) the retirement unit circuitry 1354 and the physical register file(s) circuitry 1358 perform the commit stage 1324.

FIG. 13B shows a processor core 1390 including front-end unit circuitry 1330 coupled to execution engine unit circuitry 1350, and both are coupled to memory unit circuitry 1370. The core 1390 may be a reduced instruction set architecture computing (RISC) core, a complex instruction set architecture computing (CISC) core, a very long instruction word (VLIW) core, or a hybrid or alternative core type. As yet another option, the core 1390 may be a special-purpose core, such as, for example, a network or communication core, compression engine, coprocessor core, general purpose computing graphics processing unit (GPGPU) core, graphics core, or the like.

The front-end unit circuitry 1330 may include branch prediction circuitry 1332 coupled to instruction cache circuitry 1334, which is coupled to an instruction translation lookaside buffer (TLB) 1336, which is coupled to instruction fetch circuitry 1338, which is coupled to decode circuitry 1340. In some examples, the instruction cache circuitry 1334 is included in the memory unit circuitry 1370 rather than the front-end circuitry 1330. The decode circuitry 1340 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1340 may further include address generation unit (AGU, not shown) circuitry. In some examples, the AGU generates an LSU address using forwarded register ports, and may further perform branch forwarding (e.g., immediate offset branch forwarding, LR register branch forwarding, etc.). The decode circuitry 1340 may be implemented using various different mechanisms. Examples of suitable mechanisms include, but are not limited to, look-up tables, hardware implementations, programmable logic arrays (PLAs), microcode read only memories (ROMs), etc. In some examples, the core 1390 includes a microcode ROM (not shown) or other medium that stores microcode for certain macroinstructions (e.g., in decode circuitry 1340 or otherwise within the front-end circuitry 1330). In some examples, the decode circuitry 1340 includes a micro-operation (micro-op) or operation cache (not shown) to hold/cache decoded operations, micro-tags, or micro-operations generated during the decode or other stages of the processor pipeline 1300. The decode circuitry 1340 may be coupled to rename/allocator unit circuitry 1352 in the execution engine circuitry 1350.

The execution engine circuitry 1350 includes the rename/allocator unit circuitry 1352 coupled to retirement unit circuitry 1354 and a set of one or more scheduler(s) circuitry 1356. The scheduler(s) circuitry 1356 represents any number of different schedulers, including reservations stations, central instruction window, etc. In some examples, the scheduler(s) circuitry 1356 can include arithmetic logic unit (ALU) scheduler/scheduling circuitry, ALU queues, address generation unit (AGU) scheduler/scheduling circuitry, AGU queues, etc. The scheduler(s) circuitry 1356 is coupled to the physical register file(s) circuitry 1358. Each of the physical register file(s) circuitry 1358 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 1358 includes vector registers unit circuitry, writemask registers unit circuitry, and scalar register unit circuitry. These register units may provide architectural vector registers, vector mask registers, general-purpose registers, etc. The physical register file(s) circuitry 1358 is coupled to the retirement unit circuitry 1354 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1354 and the physical register file(s) circuitry 1358 are coupled to the execution cluster(s) 1360. The execution cluster(s) 1360 includes a set of one or more execution unit(s) circuitry 1362 and a set of one or more memory access circuitry 1364. The execution unit(s) circuitry 1362 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1356, physical register file(s) circuitry 1358, and execution cluster(s) 1360 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1364). It should also be understood that where separate pipelines are used, one or more of these pipelines may be out-of-order issue/execution and the rest in-order.

In some examples, the execution engine unit circuitry 1350 may perform load store unit (LSU) address/data pipelining to an Advanced Microcontroller Bus (AMB) interface (not shown), and address phase and writeback, data phase load, store, and branches.

The set of memory access circuitry 1364 is coupled to the memory unit circuitry 1370, which includes data TLB circuitry 1372 coupled to data cache circuitry 1374 coupled to level 2 (L2) cache circuitry 1376. In some examples, the memory access circuitry 1364 may include load unit circuitry, store address unit circuitry, and store data unit circuitry, each of which is coupled to the data TLB circuitry 1372 in the memory unit circuitry 1370. The instruction cache circuitry 1334 is further coupled to the level 2 (L2) cache circuitry 1376 in the memory unit circuitry 1370. In some examples, the instruction cache 1334 and the data cache 1374 are combined into a single instruction and data cache (not shown) in L2 cache circuitry 1376, level 3 (L3) cache circuitry (not shown), and/or main memory. The L2 cache circuitry 1376 is coupled to one or more other levels of cache and eventually to a main memory.

The core 1390 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In some examples, the core 1390 includes logic to support a packed data instruction set architecture extension (e.g., AVX1, AVX2), thereby allowing the operations used by many multimedia applications to be performed using packed data.

### Graphics Execution Units

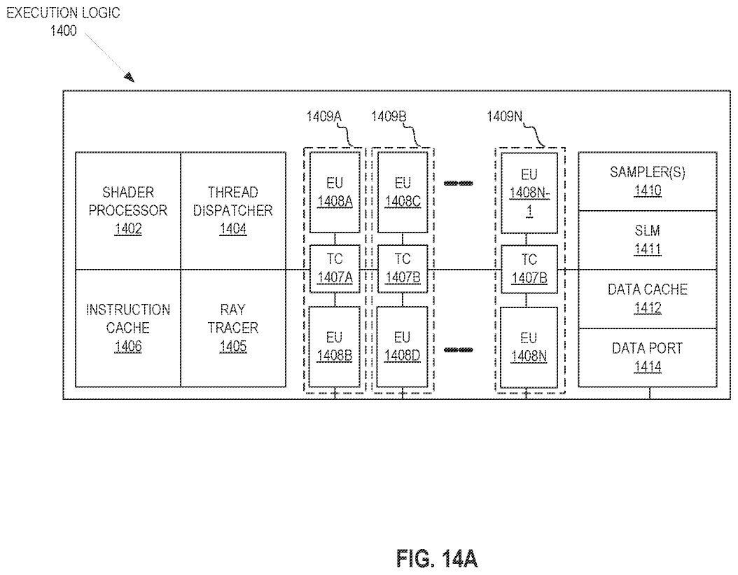

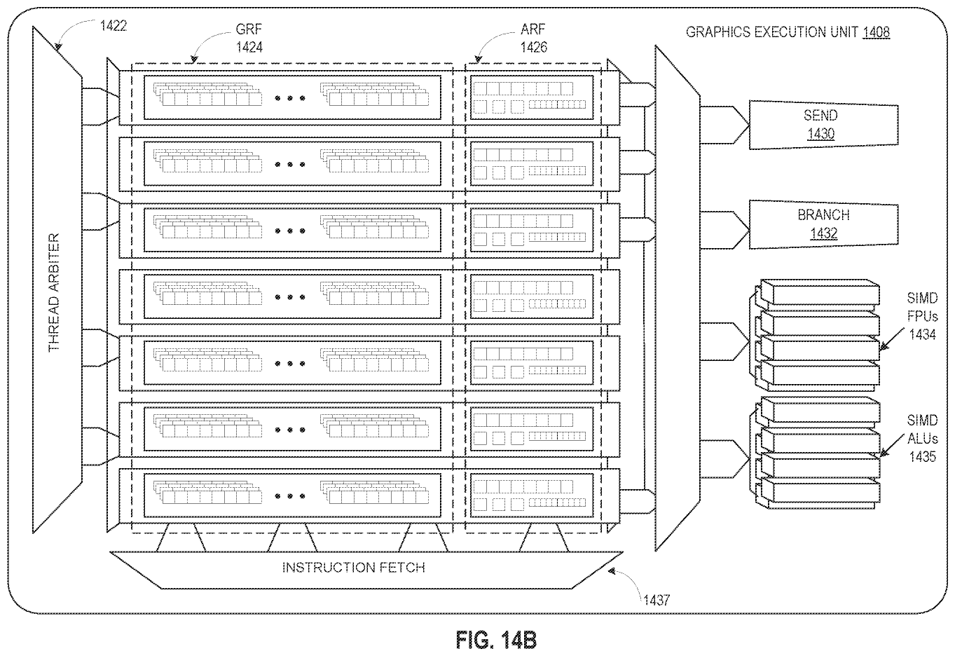

FIGS. 14A-14B illustrate thread execution logic 1400 including an array of processing elements employed in a graphics processor core according to examples described herein. Elements of FIGS. 14A-14B having the same reference numbers (or names) as the elements of any other figure herein can operate or function in any manner similar to that described elsewhere herein, but are not limited to such. FIG. 14A is representative of an execution unit within a general-purpose graphics processor, while FIG. 14B is representative of an execution unit that may be used within a compute accelerator.

As illustrated in FIG. 14A, in some examples thread execution logic 1400 includes a shader processor 1402, a thread dispatcher 1404, instruction cache 1406, a scalable execution unit array including a plurality of execution units 1408A-1408N, a sampler 1410, shared local memory 1411, a data cache 1412, and a data port 1414. In some examples the scalable execution unit array can dynamically scale by enabling or disabling one or more execution units (e.g., any of execution units 1408A, 1408B, 1408C, 1408D, through 1408N-1 and 1408N) based on the computational requirements of a workload. In some examples the included components are interconnected via an interconnect fabric that links to each of the components. In some examples, thread execution logic 1400 includes one or more connections to memory, such as system memory or cache memory, through one or more of instruction cache 1406, data port 1414, sampler 1410, and execution units 1408A-1408N. In some examples, each execution unit (e.g. 1408A) is a stand-alone programmable general-purpose computational unit that is capable of executing multiple simultaneous hardware threads while processing multiple data elements in parallel for each thread. In various examples, the array of execution units 1408A-1408N is scalable to include any number individual execution units.

In some examples, the execution units 1408A-1408N are primarily used to execute shader programs. A shader processor 1402 can process the various shader programs and dispatch execution threads associated with the shader programs via a thread dispatcher 1404. In some examples the thread dispatcher includes logic to arbitrate thread initiation requests from the graphics and media pipelines and instantiate the requested threads on one or more execution unit in the execution units 1408A-1408N. For example, a geometry pipeline can dispatch vertex, tessellation, or geometry shaders to the thread execution logic for processing. In some examples, thread dispatcher 1404 can also process runtime thread spawning requests from the executing shader programs.

In some examples, the execution units 1408A-1408N support an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders). Each of the execution units 1408A-1408N is capable of multi-issue single instruction multiple data (SIMD) execution and multi-threaded operation enables an efficient execution environment in the face of higher latency memory accesses. Each hardware thread within each execution unit has a dedicated high-bandwidth register file and associated independent thread-state. Execution is multi-issue per clock to pipelines capable of integer, single and double precision floating point operations, SIMD branch capability, logical operations, transcendental operations, and other miscellaneous operations. While waiting for data from memory or one of the shared functions, dependency logic within the execution units 1408A-1408N causes a waiting thread to sleep until the requested data has been returned. While the waiting thread is sleeping, hardware resources may be devoted to processing other threads. For example, during a delay associated with a vertex shader operation, an execution unit can perform operations for a pixel shader, fragment shader, or another type of shader program, including a different vertex shader. Various examples can apply to use execution by use of Single Instruction Multiple Thread (SIMT) as an alternate to use of SIMD or in addition to use of SIMD. Reference to a SIMD core or operation can apply also to SIMT or apply to SIMD in combination with SIMT.

Each execution unit in execution units 1408A-1408N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some examples, execution units 1408A-1408N support integer and floating-point data types.

The execution unit instruction set includes SIMD instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

In some examples one or more execution units can be combined into a fused execution unit 1409A-1409N having thread control logic (1407A-1407N) that is common to the fused EUs. Multiple EUs can be fused into an EU group. Each EU in the fused EU group can be configured to execute a separate SIMD hardware thread. The number of EUs in a fused EU group can vary according to examples. Additionally, various SIMD widths can be performed per-EU, including but not limited to SIMD8, SIMD16, and SIMD32. Each fused graphics execution unit 1409A-1409N includes at least two execution units. For example, fused execution unit 1409A includes a first EU 1408A, second EU 1408B, and thread control logic 1407A that is common to the first EU 1408A and the second EU 1408B. The thread control logic 1407A controls threads executed on the fused graphics execution unit 1409A, allowing each EU within the fused execution units 1409A-1409N to execute using a common instruction pointer register.

One or more internal instruction caches (e.g., 1406) are included in the thread execution logic 1400 to cache thread instructions for the execution units. In some examples, one or more data caches (e.g., 1412) are included to cache thread data during thread execution. Threads executing on the execution logic 1400 can also store explicitly managed data in the shared local memory 1411. In some examples, a sampler 1410 is included to provide texture sampling for 3D operations and media sampling for media operations. In some examples, sampler 1410 includes specialized texture or media sampling functionality to process texture or media data during the sampling process before providing the sampled data to an execution unit.

During execution, the graphics and media pipelines send thread initiation requests to thread execution logic 1400 via thread spawning and dispatch logic. Once a group of geometric objects has been processed and rasterized into pixel data, pixel processor logic (e.g., pixel shader logic, fragment shader logic, etc.) within the shader processor 1402 is invoked to further compute output information and cause results to be written to output surfaces (e.g., color buffers, depth buffers, stencil buffers, etc.). In some examples, a pixel shader or fragment shader calculates the values of the various vertex attributes that are to be interpolated across the rasterized object. In some examples, pixel processor logic within the shader processor 1402 then executes an application programming interface (API)-supplied pixel or fragment shader program. To execute the shader program, the shader processor 1402 dispatches threads to an execution unit (e.g., 1408A) via thread dispatcher 1404. In some examples, shader processor 1402 uses texture sampling logic in the sampler 1410 to access texture data in texture maps stored in memory. Arithmetic operations on the texture data and the input geometry data compute pixel color data for each geometric fragment, or discards one or more pixels from further processing.

In some examples, the data port 1414 provides a memory access mechanism for the thread execution logic 1400 to output processed data to memory for further processing on a graphics processor output pipeline. In some examples, the data port 1414 includes or couples to one or more cache memories (e.g., data cache 1412) to cache data for memory access via the data port.

In some examples, the execution logic 1400 can also include a ray tracer 1405 that can provide ray tracing acceleration functionality. The ray tracer 1405 can support a ray tracing instruction set that includes instructions/functions for ray generation.

FIG. 14B illustrates exemplary internal details of an execution unit 1408, according to examples. A graphics execution unit 1408 can include an instruction fetch unit 1437, a general register file array (GRF) 1424, an architectural register file array (ARF) 1426, a thread arbiter 1422, a send unit 1430, a branch unit 1432, a set of SIMD floating point units (FPUs) 1434, and in some examples a set of dedicated integer SIMD ALUs 1435. The GRF 1424 and ARF 1426 includes the set of general register files and architecture register files associated with each simultaneous hardware thread that may be active in the graphics execution unit 1408. In some examples, per thread architectural state is maintained in the ARF 1426, while data used during thread execution is stored in the GRF 1424. The execution state of each thread, including the instruction pointers for each thread, can be held in thread-specific registers in the ARF 1426.

In some examples the graphics execution unit 1408 has an architecture that is a combination of Simultaneous Multi-Threading (SMT) and fine-grained Interleaved Multi-Threading (IMT). The architecture has a modular configuration that can be fine-tuned at design time based on a target number of simultaneous threads and number of registers per execution unit, where execution unit resources are divided across logic used to execute multiple simultaneous threads. The number of logical threads that may be executed by the graphics execution unit 1408 is not limited to the number of hardware threads, and multiple logical threads can be assigned to each hardware thread.

In some examples, the graphics execution unit 1408 can co-issue multiple instructions, which may each be different instructions. The thread arbiter 1422 of the graphics execution unit thread 1408 can dispatch the instructions to one of the send unit 1430, branch unit 1432, or SIMD FPU(s) 1434 for execution. Each execution thread can access 128 general-purpose registers within the GRF 1424, where each register can store 32 bytes, accessible as a SIMD 8-element vector of 32-bit data elements. In some examples, each execution unit thread has access to 4 Kbytes within the GRF 1424, although examples are not so limited, and greater or fewer register resources may be provided in other examples. In some examples the graphics execution unit 1408 is partitioned into seven hardware threads that can independently perform computational operations, although the number of threads per execution unit can also vary according to examples. For example, in some examples up to 16 hardware threads are supported. In an example in which seven threads may access 4 Kbytes, the GRF 1424 can store a total of 28 Kbytes. Where 16 threads may access 4 Kbytes, the GRF 1424 can store a total of 64 Kbytes. Flexible addressing modes can permit registers to be addressed together to build effectively wider registers or to represent strided rectangular block data structures.

In some examples, memory operations, sampler operations, and other longer-latency system communications are dispatched via “send” instructions that are executed by the message passing send unit 1430. In some examples, branch instructions are dispatched to a dedicated branch unit 1432 to facilitate SIMD divergence and eventual convergence.

In some examples the graphics execution unit 1408 includes one or more SIMD floating point units (FPU(s)) 1434 to perform floating-point operations. In some examples, the FPU(s) 1434 also support integer computation. In some examples the FPU(s) 1434 can SIMD execute up to M number of 32-bit floating-point (or integer) operations, or SIMD execute up to 2M 16-bit integer or 16-bit floating-point operations. In some examples, at least one of the FPU(s) provides extended math capability to support high-throughput transcendental math functions and double precision 64-bit floating-point. In some examples, a set of 8-bit integer SIMD ALUs 1435 are also present, and may be specifically optimized to perform operations associated with machine learning computations.

In some examples, arrays of multiple instances of the graphics execution unit 1408 can be instantiated in a graphics sub-core grouping (e.g., a sub-slice). For scalability, product architects can choose the exact number of execution units per sub-core grouping. In some examples the execution unit 1408 can execute instructions across a plurality of execution channels. In a further example, each thread executed on the graphics execution unit 1408 is executed on a different channel.

### Graphics Pipeline

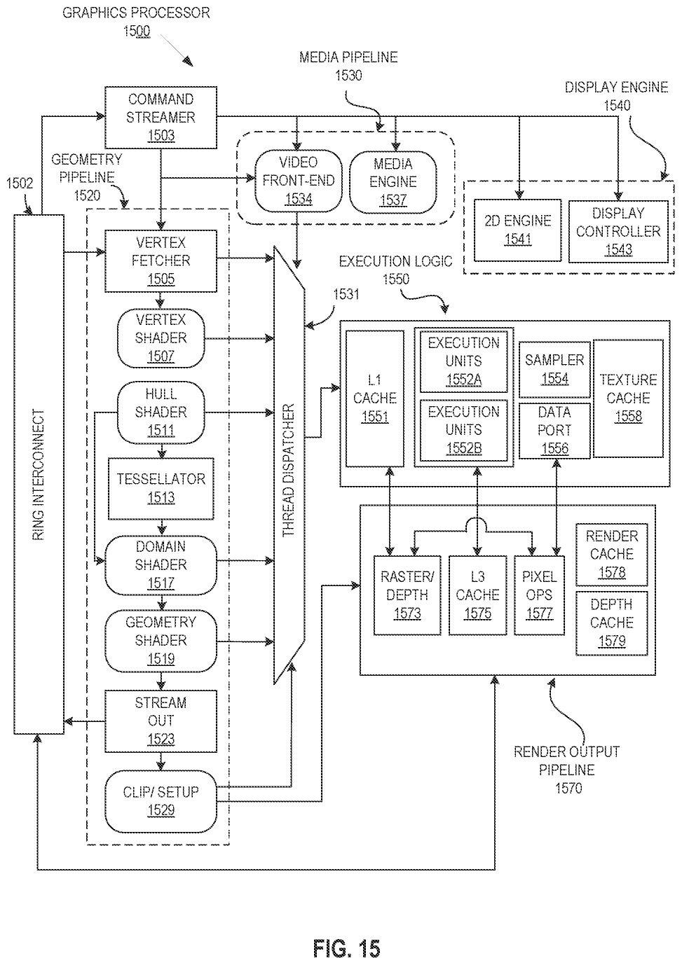

FIG. 15 is a block diagram of another example of a graphics processor 1500. Elements of FIG. 15 having the same reference numbers (or names) as the elements of any other figure herein can operate or function in any manner similar to that described elsewhere herein, but are not limited to such.

In some examples, graphics processor 1500 includes a geometry pipeline 1520, a media pipeline 1530, a display engine 1540, thread execution logic 1550, and a render output pipeline 1570. In some examples, graphics processor 1500 is a graphics processor within a multi-core processing system that includes one or more general-purpose processing cores. The graphics processor is controlled by register writes to one or more control registers (not shown) or via commands issued to graphics processor 1500 via a ring interconnect 1502. In some examples, ring interconnect 1502 couples graphics processor 1500 to other processing components, such as other graphics processors or general-purpose processors. Commands from ring interconnect 1502 are interpreted by a command streamer 1503, which supplies instructions to individual components of the geometry pipeline 1520 or the media pipeline 1530.

In some examples, command streamer 1503 directs the operation of a vertex fetcher 1505 that reads vertex data from memory and executes vertex-processing commands provided by command streamer 1503. In some examples, vertex fetcher 1505 provides vertex data to a vertex shader 1507, which performs coordinate space transformation and lighting operations to each vertex. In some examples, vertex fetcher 1505 and vertex shader 1507 execute vertex-processing instructions by dispatching execution threads to execution units 1552A-1552B via a thread dispatcher 1531.

In some examples, execution units 1552A-1552B are an array of vector processors having an instruction set for performing graphics and media operations. In some examples, execution units 1552A-1552B have an attached L1 cache 1551 that is specific for each array or shared between the arrays. The cache can be configured as a data cache, an instruction cache, or a single cache that is partitioned to contain data and instructions in different partitions.

In some examples, geometry pipeline 1520 includes tessellation components to perform hardware-accelerated tessellation of 3D objects. In some examples, a programmable hull shader 1511 configures the tessellation operations. A programmable domain shader 1517 provides back-end evaluation of tessellation output. A tessellator 1513 operates at the direction of hull shader 1511 and contains special purpose logic to generate a set of detailed geometric objects based on a coarse geometric model that is provided as input to geometry pipeline 1520. In some examples, if tessellation is not used, tessellation components (e.g., hull shader 1511, tessellator 1513, and domain shader 1517) can be bypassed.

In some examples, complete geometric objects can be processed by a geometry shader 1519 via one or more threads dispatched to execution units 1552A-1552B, or can proceed directly to the clipper 1529. In some examples, the geometry shader operates on entire geometric objects, rather than vertices or patches of vertices as in previous stages of the graphics pipeline. If the tessellation is disabled the geometry shader 1519 receives input from the vertex shader 1507. In some examples, geometry shader 1519 is programmable by a geometry shader program to perform geometry tessellation if the tessellation units are disabled.

Before rasterization, a clipper 1529 processes vertex data. The clipper 1529 may be a fixed function clipper or a programmable clipper having clipping and geometry shader functions. In some examples, a rasterizer and depth test component 1573 in the render output pipeline 1570 dispatches pixel shaders to convert the geometric objects into per pixel representations. In some examples, pixel shader logic is included in thread execution logic 1550. In some examples, an application can bypass the rasterizer and depth test component 1573 and access un-rasterized vertex data via a stream out unit 1523.

The graphics processor 1500 has an interconnect bus, interconnect fabric, or some other interconnect mechanism that allows data and message passing amongst the major components of the processor. In some examples, execution units 1552A-1552B and associated logic units (e.g., L1 cache 1551, sampler 1554, texture cache 1558, etc.) interconnect via a data port 1556 to perform memory access and communicate with render output pipeline components of the processor. In some examples, sampler 1554, caches 1551, 1558 and execution units 1552A-1552B each have separate memory access paths. In some examples the texture cache 1558 can also be configured as a sampler cache.

In some examples, render output pipeline 1570 contains a rasterizer and depth test component 1573 that converts vertex-based objects into an associated pixel-based representation. In some examples, the rasterizer logic includes a windower/masker unit to perform fixed function triangle and line rasterization. An associated render cache 1578 and depth cache 1579 are also available in some examples. A pixel operations component 1577 performs pixel-based operations on the data, though in some instances, pixel operations associated with 2D operations (e.g., bit block image transfers with blending) are performed by the 2D engine 1541, or substituted at display time by the display controller 1543 using overlay display planes. In some examples, a shared L3 cache 1575 is available to all graphics components, allowing the sharing of data without the use of main system memory.

In some examples, graphics processor media pipeline 1530 includes a media engine 1537 and a video front-end 1534. In some examples, video front-end 1534 receives pipeline commands from the command streamer 1503. In some examples, media pipeline 1530 includes a separate command streamer. In some examples, video front-end 1534 processes media commands before sending the command to the media engine 1537. In some examples, media engine 1537 includes thread spawning functionality to spawn threads for dispatch to thread execution logic 1550 via thread dispatcher 1531.

In some examples, graphics processor 1500 includes a display engine 1540. In some examples, display engine 1540 is external to processor 1500 and couples with the graphics processor via the ring interconnect 1502, or some other interconnect bus or fabric. In some examples, display engine 1540 includes a 2D engine 1541 and a display controller 1543. In some examples, display engine 1540 contains special purpose logic capable of operating independently of the 3D pipeline. In some examples, display controller 1543 couples with a display device (not shown), which may be a system integrated display device, as in a laptop computer, or an external display device attached via a display device connector.

In some examples, the geometry pipeline 1520 and media pipeline 1530 are configurable to perform operations based on multiple graphics and media programming interfaces and are not specific to any one application programming interface (API). In some examples, driver software for the graphics processor translates API calls that are specific to a particular graphics or media library into commands that can be processed by the graphics processor. In some examples, support is provided for the Open Graphics Library (OpenGL), Open Computing Language (OpenCL), and/or Vulkan graphics and compute API, all from the Khronos Group. In some examples, support may also be provided for the Direct3D library from the Microsoft Corporation. In some examples, a combination of these libraries may be supported. Support may also be provided for the Open Source Computer Vision Library (OpenCV). A future API with a compatible 3D pipeline would also be supported if a mapping can be made from the pipeline of the future API to the pipeline of the graphics processor.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

### Further Examples

Example 1 provides an exemplary method comprising: providing a set of buffers by a storage of a load balancer to store packets to be distributed by the load balancer; distributing the packets by the load balancer to a set of cores of a computer processor to be processed by the set of cores; responsive to buffer utilization in the storage over a first threshold, obtaining by circuitry of the load balancer, from top of a memory stack coupled to the storage, additional buffers to store the packets to be distributed; and responsive to buffer utilization in the storage below a second threshold, returning by the circuitry of the load balancer, available buffers in the storage to the top of the memory stack.

Example 2 includes the substance of Example 1, wherein the available buffers from the storage were used to store packets that have been distributed by the load balancer.

Example 3 includes the substance of Examples 1 to 2, wherein a determination that the buffer utilization in the storage being over the first threshold is performed upon a set of packets being queued to a receiving queue of the load balancer.

Example 4 includes the substance of Examples 1 to 3, wherein a determination that the buffer utilization in the storage being below the second threshold is performed upon completion of a set of packets being transmitted from a transmitting queue of the load balancer.

Example 5 includes the substance of Examples 1 to 4, wherein each of a receiving queue of the load balancer and a transmitting queue of the load balancer is a set of circular buffers.

Example 6 includes the substance of Examples 1 to 5, wherein for a packet processed by a core and to be transmitted by the load balancer through a transmitting queue of the load balancer, an indication is set to indicate whether to return a corresponding buffer to the top of the memory stack upon completion of queuing the packet in the transmitting queue.

Example 7 includes the substance of Examples 1 to 6, wherein the indication is to indicate that the corresponding buffer is not to return to the top of the memory stack due to packet allocation to the corresponding buffer being performed by a party other than the circuitry of the load balancer.

Example 8 includes the substance of Examples 1 to 7, wherein the indication is to indicate that the corresponding buffer is to return to the top of the memory stack upon the packet not being transmitted by the load balancer.

Example 9 includes the substance of Examples 1 to 8, wherein the circuitry is coupled to a network interface module of the load balancer, from which the packets to be distributed are received, and to which packets processed by the set of cores are aggregated.

Example 10 includes the substance of Examples 1 to 9, wherein the storage is to provide and release the set of buffers in an order of a latest available buffer to be provided first to incoming packets to the load balancer.

Example 11 includes the substance of Examples 1 to 10, wherein a portion of the storage is excluded from determining the buffer utilization to interact with the memory stack, and wherein the portion of the storage is to be used for buffer management independently from the circuitry of the load balancer.

Example 12 provides an apparatus comprising: a storage to provide a set of buffers to store packets to be distributed by the apparatus; and circuitry for buffer management to distribute the packets to a set of cores of a computer processor to be processed by the set of cores, wherein responsive to buffer utilization in the storage over a first threshold, the circuitry is to obtain, from top of a memory stack coupled to the storage, additional buffers to the apparatus to store the packets to be distributed, and responsive to the buffer utilization in the storage below a second threshold, the circuitry is to return available buffers in the storage to the top of the memory stack.

Example 13 includes the substance of Example 12, wherein the available buffers from the storage were used to store packets that have been distributed by the apparatus.

Example 14 includes the substance of Examples 12 to 13, wherein a determination that the buffer utilization in the storage being over the first threshold is performed upon a set of packets being queued to a receiving queue of the apparatus.

Example 15 includes the substance of Examples 12 to 14, wherein a determination that the buffer utilization in the storage being below the second threshold is performed upon completion of a set of packets being transmitted from a transmitting queue of the apparatus.

Example 16 includes the substance of Examples 12 to 15, wherein each of a receiving queue of the apparatus and a transmitting queue of the apparatus is a set of circular buffers.

Example 17 provides an exemplary machine-readable storage medium storing instructions that when executed by a processor, are capable of causing the processor to perform: providing a set of buffers by a storage of a load balancer to store packets to be distributed by a load balancer; distributing the packets by the apparatus to a set of cores of a computer processor to be processed by the set of cores; responsive to buffer utilization in the storage over a first threshold, obtaining by circuitry of the apparatus, from top of a memory stack coupled to the storage, additional buffers to store the packets to be distributed; and responsive to buffer utilization in the storage below a second threshold, returning by the circuitry of the load balancer, available buffers in the storage to the top of the memory stack.

Example 18 includes the substance of Example 17, wherein for a packet processed by a core and to be transmitted by the load balancer through a transmitting queue of the load balancer, an indication is set to indicate whether to return a corresponding buffer to the top of the memory stack upon completion of queuing the packet in the transmitting queue.

Example 19 includes the substance of Examples 17 to 18, wherein the circuitry is coupled to a network interface module of the load balancer, from which the packets to be distributed are received, and to which packets processed by the set of cores are aggregated.

Example 20 includes the substance of Examples 17 to 19, wherein the storage is to provide and release the set of buffers in an order of a latest available buffer to be provided first to incoming packets to the load balancer.

Example 21 provides an exemplary buffer management system for packet processing comprising: a load balancer comprising circuitry configured to connect to a network interface controller (NIC); a memory external to the load balancer for storing buffers; a set of watermark levels within the load balancer for managing buffer replenishment and recycling; and a mechanism for the load balancer to furnish buffers to the NIC on receive (Rx) and recycle buffers on transmit (Tx).

Example 22 includes the substance of Example 21, wherein the load balancer is further configured to manage the buffers without substantial involvement of software (SW) after initial setup.

Example 23 includes the substance of Examples 21 to 22, wherein the load balancer includes a buffer manager integrated with the load balancer to manage the memory.

Example 24 includes the substance of Examples 21 to 23, wherein the load balancer is configured to react within a time corresponding to one of more of the watermark levels to replenish NIC receive rings (RxRings) to maintain a low number of empty buffers.

Example 25 includes the substance of Examples 21 to 24, wherein the load balancer is configured to handle packets dropped by software (SW) and packets originating from memory outside of the load balancer's control.

Example 26 includes the substance of Examples 21 to 25, wherein the load balancer includes a transmit descriptor signal interface (TxDSI) and/or a receive descriptor signal interface (RxDSI) for connecting to NIC transmit (Tx) and/or receive (Rx) respectively.

Example 27 includes the substance of Examples 21 to 26, wherein the load balancer is configured to parse a NIC transmit ring (TxRing) for buffers to recycle based on completions from transmitted packets.

Example 28 includes the substance of Examples 21 to 27, wherein the load balancer utilizes a Drop/Notify/Recycle (DNR) indicia within an event structure to manage packet transmission and buffer recycling.

Example 29 includes the substance of Examples 21 to 28, wherein the DNR indicia indicates whether a packet's buffers originated from the load balancer and whether the buffers should be recycled.

Example 30 includes the substance of Examples 21 to 29, wherein the load balancer is configured to provide notifications to software (SW) when packets with buffers not originating from the load balancer are transmitted.

Example 31 includes the substance of Examples 21 to 30, wherein the load balancer is configured to recycle buffers when packets are dropped by software (SW).

Example 32 includes the substance of Examples 21 to 31, wherein the load balancer is configured to accumulate credit when software (SW) returns credit without recycling buffers or transmitting packets.

Example 33 includes the substance of Examples 21 to 32, further comprising a cache within the load balancer for temporarily storing buffers.

Example 34 includes the substance of Examples 21 to 33, wherein the cache operates in a last-in-first-out (LIFO) fashion.

Example 35 includes the substance of Examples 21 to 34, wherein the cache is divided into quadrants, each quadrant being capable of being reordered based on buffer availability.

Example 36 includes the substance of Examples 21 to 35, wherein the reordering of quadrants preserves the LIFO nature of the cache.

Example 37 provides computer-readable medium comprising instructions which, when executed by a processor, perform a method for managing buffers in a packet processing application, the method comprising: controlling a load balancer comprising circuitry to communicate to a network interface controller (NIC); managing buffer replenishment and recycling based on a set of watermark levels within the load balancer; and furnishing buffers to the NIC on receive (Rx) operations and recycling buffers on transmit (Tx) operations by the load balancer.

Example 38 includes the substance of Example 37, wherein the method further comprises managing the buffers by the load balancer without substantial involvement of software (SW) after initial setup.

Example 39 includes the substance of Examples 37 to 38, wherein the method further comprises reacting within a time window corresponding a network slot time by the load balancer to replenish NIC receive rings (RxRings) to maintain a low number of empty buffers.

Example 40 includes the substance of Examples 37 to 39, wherein the method further comprises handling by the load balancer of packets dropped by software (SW) and packets originating from memory outside of the load balancer's control.

Example 41 includes the substance of Examples 37 to 40, wherein the method further comprises utilizing a Drop/Notify/Recycle (DNR) indicia within an event structure by the load balancer to manage packet transmission and buffer recycling.

Example 42 includes the substance of Examples 37 to 41, wherein the method further comprises accumulating credit by the load balancer when software (SW) returns credit without recycling buffers or transmitting packets.

Example 43 includes the substance of Examples 37 to 42, wherein the method further comprises operating a cache within the load balancer in a last-in-first-out (LIFO) fashion.

Example 44 includes the substance of Examples 37 to 43, wherein the method further comprises dividing the cache into partitions and reordering the partitions based on buffer availability while preserving the LIFO nature.

Example 45 provides an exemplary apparatus for managing buffers in a packet processing application comprises: a load balancer comprising circuitry configured to directly connect to a network interface controller (NIC) and to manage buffer replenishment and recycling based on a set of watermark levels within the load balancer; and a first memory external to the load balancer for storing buffers, wherein the load balancer is further configured to furnish buffers to the NIC on receive (Rx) and recycle buffers on transmit (Tx).

Example 46 includes the substance of Example 45, wherein the load balancer within the apparatus is further configured to manage the buffers without substantial involvement of software (SW) after initial setup.

Example 47 includes the substance of Examples 45 to 46, wherein the load balancer within the apparatus includes a buffer manager integrated with the load balancer to manage the first memory.

Example 48 includes the substance of Examples 45 to 47, wherein the load balancer is configured to react quickly to replenish NIC receive rings (RxRings) to maintain a low number of empty buffers.

Example 49 includes the substance of Example 45 to 48, wherein the load balancer is configured to handle packets dropped by software (SW) and packets originating from a second memory, wherein the second memory is outside of the load balancer's management.

Example 50 includes the substance of Examples 45 to 49, wherein the load balancer includes a transmit descriptor signal interface (TxDSI) and a receive descriptor signal interface (RxDSI) for connecting to NIC transmit (Tx) and receive (Rx) respectively.

Example 51 includes the substance of Examples 45 to 50, wherein the load balancer is configured to parse a NIC transmit ring (TxRing) for buffers to recycle based on completions from transmitted packets.

Example 52 includes the substance of Examples 45 to 51, wherein the load balancer within the apparatus utilizes indicia within an event structure to manage packet transmission and buffer recycling.

Example 53 includes the substance of Examples 45 to 52, wherein the indicia indicate whether a packet's buffers originated from the load balancer and whether the buffers should be recycled.

Example 54 includes the substance of Example 45 to 53, wherein the load balancer is configured to provide notifications to software (SW) when packets with buffers not originating from the load balancer are transmitted.

Example 55 includes the substance of Examples 45 to 54, wherein the load balancer is configured to recycle buffers when packets are dropped by software (SW).

Example 56 includes the substance of Examples 45 to 55, wherein the load balancer is configured to accumulate credit when software (SW) returns credit without recycling buffers or transmitting packets.

Example 57 includes the substance of Examples 45 to 56, further comprising a cache within the load balancer for temporarily storing buffers.

Example 58 includes the substance of Examples 45 to 57, wherein the cache operates in a last-in-first-out (LIFO) fashion.

Example 59 includes the substance of Example 45 to 58, wherein the cache is divided into segments, each segment being capable of being reordered based on buffer availability.

Example 60 includes the substance of Examples 45 to 59, wherein the reordering of segments preserves the LIFO nature of the cache.

Example 61 includes the substance of Examples 45 to 60, wherein the load balancer is further configured to interface with a computer program product comprising a non-transitory computer-readable medium having computer-readable program code embodied therein, the computer-readable program code adapted to be executed to implement a method for managing buffers in the packet processing application.

Additional Explanation

Embodiments of the disclosure may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer-readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical, or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more buses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the disclosure may be implemented using different combinations of software, firmware, and/or hardware. Throughout this detailed description, for the purposes of explanation, numerous specific details were set forth in order to provide a thorough understanding of the present disclosure. It will be apparent, however, to one skilled in the art that the disclosure may be practiced without some of these specific details. In certain instances, well-known structures and functions were not described in elaborate detail in order to avoid obscuring the subject matter of the present disclosure. Accordingly, the scope and spirit of the disclosure should be judged in terms of the claims which follow.

What is claimed is:

1. A method comprising:
providing a set of buffers by a storage of a load balancer to store packets to be distributed by the load balancer;
distributing the packets by the load balancer to a set of cores of a computer processor to be processed by the set of cores;
responsive to buffer utilization in the storage over a first threshold, obtaining by circuitry of the load balancer, from top of a memory stack coupled to the storage, additional buffers to store the packets to be distributed; and
responsive to buffer utilization in the storage below a second threshold, returning by the circuitry of the load balancer, available buffers in the storage to the top of the memory stack.

2. The method of claim 1, wherein the available buffers from the storage were used to store packets that have been distributed by the load balancer.

3. The method of claim 1, wherein a determination that the buffer utilization in the storage being over the first threshold is performed upon a set of packets being queued to a receiving queue of the load balancer.

4. The method of claim 1, wherein a determination that the buffer utilization in the storage being below the second threshold is performed upon completion of a set of packets being transmitted from a transmitting queue of the load balancer.

5. The method of claim 1, wherein each of a receiving queue of the load balancer and a transmitting queue of the load balancer is a set of circular buffers.

6. The method of claim 1, wherein for a packet processed by a core and to be transmitted by the load balancer through a transmitting queue of the load balancer, an indication is set to indicate whether to return a corresponding buffer to the top of the memory stack upon completion of queuing the packet in the transmitting queue.

7. The method of claim 6, wherein the indication is to indicate that the corresponding buffer is not to return to the top of the memory stack due to packet allocation to the corresponding buffer being performed by a party other than the circuitry of the load balancer.

8. The method of claim 6, wherein the indication is to indicate that the corresponding buffer is to return to the top of the memory stack upon the packet not being transmitted by the load balancer.

9. The method of claim 1, wherein the circuitry is coupled to a network interface module of the load balancer, from which the packets to be distributed are received, and to which packets processed by the set of cores are aggregated.

10. The method of claim 1, wherein the storage is to provide and release the set of buffers in an order of a latest available buffer to be provided first to incoming packets to the load balancer.

11. The method of claim 1, wherein a portion of the storage is excluded from determining the buffer utilization to interact with the memory stack, and wherein the portion of the storage is to be used for buffer management independently from the circuitry of the load balancer.

12. An apparatus comprising:
a storage to provide a set of buffers to store packets to be distributed by the apparatus; and
circuitry for buffer management to distribute the packets to a set of cores of a computer processor to be processed by the set of cores,
wherein responsive to buffer utilization in the storage over a first threshold, the circuitry is to obtain, from top of a memory stack coupled to the storage, additional buffers to the apparatus to store the packets to be distributed, and responsive to the buffer utilization in the storage below a second threshold, the circuitry is to return available buffers in the storage to the top of the memory stack.

13. The apparatus of claim 12, wherein the available buffers from the storage were used to store packets that have been distributed by the apparatus.

14. The apparatus of claim 12, wherein a determination that the buffer utilization in the storage being over the first threshold is performed upon a set of packets being queued to a receiving queue of the apparatus.

15. The apparatus of claim 12, wherein a determination that the buffer utilization in the storage being below the second threshold is performed upon completion of a set of packets being transmitted from a transmitting queue of the apparatus.

16. The apparatus of claim 12, wherein each of a receiving queue of the apparatus and a transmitting queue of the apparatus is a set of circular buffers.

17. A non-transitory machine-readable storage medium storing instructions that when executed by a processor, are capable of causing the processor to perform:
providing a set of buffers by a storage of a load balancer to store packets to be distributed by an load balancer;
distributing the packets by the load balancer to a set of cores of a computer processor to be processed by the set of cores;
responsive to buffer utilization in the storage over a first threshold, obtaining by circuitry of the load balancer, from top of a memory stack coupled to the storage, additional buffers to store the packets to be distributed; and
responsive to buffer utilization in the storage below a second threshold, returning by the circuitry of the load balancer, available buffers in the storage to the top of the memory stack.

18. The non-transitory machine-readable storage medium of claim 17, wherein for a packet processed by a core and to be transmitted by the load balancer through a transmitting queue of the load balancer, an indication is set to indicate whether to return a corresponding buffer to the top of the memory stack upon completion of queuing the packet in the transmitting queue.

19. The non-transitory machine-readable storage medium of claim 17, wherein the circuitry is coupled to a network interface module of the load balancer, from which the packets to be distributed are received, and to which packets processed by the set of cores are aggregated.

20. The non-transitory machine-readable storage medium of claim 17, wherein the storage is to provide and release the set of buffers in an order of a latest available buffer to be provided first to incoming packets to the load balancer.
